(19) United States
(12) Patent Application Publication
(10) Pub. No.: US 2015/0242585 A1
(43) Pub. Date: Aug. 27, 2015

(54) Method and Apparatus for Monitoring a User and Providing a Schedule for a User

(71) Applicant: Judy SPIEGEL, Englewood, NJ (US)

(72) Inventor: Judy SPIEGEL, Englewood, NJ (US)

(21) Appl. No.: 14/629,180

(22) Filed: Feb. 23, 2015

Related U.S. Application Data
(60) Provisional application No. 61/942,957, filed on Feb. 21, 2014.

(51) Int. Cl. G06F 19/00; G06Q 10/10; G06Q 50/22

(52) U.S. Cl. CPC G06F 19/3418; G06Q 50/22; G06Q 10/109

(57) ABSTRACT

A multipurpose device and/or application running on a smartphone device or the like that allows a user to be reached with discreet reminders and maintain an accurate schedule. Also disclosed is an application for patients, particularly Alzheimer patients. Preferably, the application adapts as the user condition declines. A caregiver application and/or assisted living application is disclosed and depicted as well

### RELATED APPLICATIONS

This application claims priority from U.S. Provisional Patent Application Ser. No. 61/942,957 which was filed on Feb. 21, 2014.

### BACKGROUND OF THE INVENTION

1. Field of the Invention

The present invention relates generally to monitoring systems and more specifically, it relates to a monitoring system for monitoring an individual and providing a reminder system for the individual. The monitoring system is one of a standalone device or an application on a device such as a smartphone.

2. Description of the Related Art

Any discussion of the prior art throughout the specification should in no way be considered as an admission that such prior art is widely known or forms part of common general knowledge in the field.

Monitoring systems have been in use for years and are utilized in a variety of industries and services. One area in which monitoring systems are utilized is to device over young children/animals to ensure they do not stray from a designated area. Another area that may also utilize monitoring systems is in the area of patient care units.

Monitoring systems may serve several purposes. The monitoring systems may allow a leader or primary care giver to efficiently keep track of a large group of individuals. The monitoring systems also may install a sense of safety within the individual being monitored, wherein the individual feels safe that they are in the designated area.

Many commonly utilized monitoring systems do not incorporate features that allow the monitoring system to be easily managed to incorporate various changing entities, such as distances utilized for boundary areas and various alarm devices. Because of the general lack of efficiency and practicality in the prior art, there is the need for a new and improved individual monitoring system for efficiently monitoring when individuals stray from a designated area.

### SUMMARY OF THE INVENTION

A multipurpose device and/or application running on a smartphone device or the like that allows a user to be reached with discreet reminders and maintain an accurate schedule. Also disclosed is an application for patients, particularly Alzheimer patients particularly applicable to high functioning individuals. Preferably, the application adapts as the user condition declines. A caregiver application and/or assisted living application is disclosed and depicted as well as contacts-detail of features. In a preferred embodiment, the application is operable on multiple platforms of is customized for each platform.

In a preferred embodiment, a general application is disclosed that guides a user through a daily schedule including such activities as shopping, doctor appointments, gym visits, hair salons, and the like. Each scheduled activity is preferably accompanied by a walk-through that prompts the user to perform activities or ask specific questions. The questions are adaptive.

It should be noted that one or more of the disclosed features can be provided in an application or a standalone device.

In one embodiment, the application or device is adapted to communicate with a doctor application or a hospital application. The application is either queried and/or automatically provides selected patient data. The provided data can include one or more of patient name, age, date of birth, insurance information, current prescriptions, prior diagnoses, and the like. Similarly, the doctor or hospital application can also update the user device or application.

### BRIEF DESCRIPTION OF FIGURES

FIG. 1 is a login screen for an application;

FIG. 2 is a screen for inputting medical records;

FIG. 3 is daily welcome screen with one appointment;

FIG. 4 is an expanded view of the appointment of FIG. 3;

FIG. 5 is a medication reminder screen;

FIG. 6 is a screen for adding an appointment;

FIG. 7 is a screen for adding a diagnosis;

FIG. 8 is a screen showing contacts and important records;

FIG. 9 is a screen showing appointments;

FIG. 10 is a screen showing appointment details;

FIG. 11 is a screen showing appointment details.

### DETAILED DESCRIPTION

Disclosed is a multipurpose device or application running on a device such as a smartphone that allows the user of the device to be reached at a moment's notice. In a preferred embodiment, the device is designed using a modern look, preferably with a clamshell design. Additionally, the multipurpose device is waterproof, shockproof, and the like. The multipurpose device preferably cannot be turned off. Additionally, the multipurpose device has a safety lock that cannot be opened without an unlocking device. Thus, the device or application is secure. In one embodiment, the device is a smartphone running an application.

In one embodiment, the application or device is programmable to have one or more operating modes. These modes range from a simple operating mode to a more complex and comprehensive operating mode. In the simple operating mode unnecessary functions are not present. In the more complex modes, more functionality and controls are present.

It should be noted that the display of a standalone device embodying this invention or an application for a device would have a display that utilizes a large clear font. In this manner, users with impaired vision will not be hindered in using the device or application. The display is configured so that the orientation of the display, which includes one or more of the date, time, weather, day/night prompts, and the like are clearly displayed and can vary with the orientation of the device.

While using the device or application, there is no need to navigate out of application. As an application, the application serves as a shell through which other applications are accessed. In this manner, the application can track usage and verify compliance with schedules and the like. The verification ensures accountability. For those tasks that require accountability, such as when a care recipient is in a nursing home and is scheduled for an activity, there is a signature line after the activity that is signed by the person who has taken the care recipient to the activity, appointment, etc. In this manner, the attendance is verified and the person assigned a task can be held accountable.

In one embodiment, push notification is used to open the application or provide alerts. The application preferably includes easy access to emergency contacts. Further, modifications to schedules are permitted such as a change to scheduled dosage time or dosage amount for a single time. Prompts are provided so that a user adheres to predetermined medication dosing schedules to encourage taking medication on time. Notifications are provided if a dose is missed along with preloaded instructions to account for missed doses. Preferably, the reminders sent to the care recipient and/or caregiver for missed dosages are tracked and notifications are sent to an assigned person. In this way, both the caregiver and the care recipient can be monitored by a third party. Proactive reminders are also provided. These are appropriate reminders given before, during, and after a task to help keep the care recipient organized, on-task, and prepared.

Reminders can be task or appointment specific. For example, if the care recipient has a stress test with cardiologist several reminders can be generated. Before the appointment, the reminder can be “do you need to take exercise clothes?” During the appointment the reminder can be “do you need to update your medicine list?” or prompt the care recipient to ask a specific care related question. After the appointment the reminder can prompt the user to schedule the next appointment.

In one embodiment, the caregiver is monitored. This monitoring is accomplished by the caregiver recording photographic evidence of completing a task. For example, if a medication is to be administered at a specific time or physical therapy is to be administered, the caregiver records a picture or video of the patient taking the medicine or getting the therapy. If a patient is able, the patient can also record the photographic evidence. The photographic evidence is stored on the device on which the application is being used. The photographic evidence can also be uploaded to a server or sent to a third party to confirm that the activity has been completed.

The user can set the intensity of the reminders and the format of the reminders. The reminders can be one or more of a vibration, a sound, and a textual alert. The reminders can also vary based on importance. As the importance of the reminder increases or as a time for an appointment nears, the reminder will increase in intensity with a larger font and/or more intense color. Appointment reminders are configured to notify a caregiver if the care recipient is late to an appointment. The notification can include the date and time of the appointment after a preset time has elapsed.

One feature of the application or device is a time management application. The time management application works in conjunction with a calendar and navigation programs. The time management application is configured to determine how much time until an appointment, travel time necessary to get to destination, time needed to reach subsequent appointments, and the like.

As a user prepares to embark on a trip, whether it is a walk, a trip to a store or appointment, or the like, a series of reminders are presented to the user or caregiver. The reminders include don't forget keys, bring wallet or identification, turn off lights, check gas, lock door, check cooking timer, set timer to start cooking and/or end cooking, turn off stove reminder, and the like.

In one embodiment, updates can be received anytime from anywhere. The device does not have to be connected to a PC, or the internet via a hard-wired connection or a radio link such as a wifi link, Bluetooth link, or the like. The device can also access a cellular network to receive data. In other words, the device or application receives and sends real-time data to keep the user and monitoring caregivers informed whenever and wherever the parties are. This ease of communication also allows changes to be made on the go, either directly from the mobile device or a caregiver's mobile device. Thus, either party can schedule appointments, add to care recipient's calendar, customize notifications and alerts, and the like.

In a preferred embodiment, data is stored in a memory of the device, preferably as encrypted data. In one embodiment, the data is not stored on other servers. The device is not constantly connected to internet and does not send out any private or diagnostic information making it as secure as possible. It should be noted that the data can be backed up to a PC, other servers, or the like in some situations.

To maintain security, login pass codes are used for assigned individuals to access designated information. A log is maintained of access and changes made to the information. In this manner, erroneous data changes can be investigated and reversed.

In one embodiment, all important and/or relevant information is stored by the application. The application organizes and stores personal and medical records and medical history. The personal health record tracking includes, but is not limited to the ability to store and access critical information for doctor's visit, emergencies, reference, and advanced directives such as a power of attorney, living will, DNR instructions, organ donor agreements, and the like.

The application or device includes a proactive medical questionnaire. Based on a new diagnosis, the application sends appropriate prompts with questions for a care recipient or caregiver to ask a doctor and encourage patient/caregiver participation in medical care.

The application or device maintains a medicine list and a log for dosages and historical medications. The log also contains physician information, dose, frequency, date—begin/end, time taken, reminders to reorder medicine, pharmacy contact information, prescription number, special instructions, ability to add photo of medication next to name, ability to add a contact, notes, and the like. When the log indicates that the end date for the medication has been reached, the medication information goes to medicine history. Similarly, after an end date for a treatment has been reached, the treatment goes to medical history. Similarly, medical history includes information such as blood type, immunizations, date of tetanus shot, allergies, major illnesses, surgical history, other medical conditions, diagnosis, and the like. In one embodiment, a profile completion indicator shows how much information has been inputted and encourages assigned person(s) to complete the data entry.

In one embodiment, a user or caregiver can import medical contacts from an address book, either individually or as a group.

The stored information includes, but is not limited to monitored daily routines with medical needs. A to do list is maintained. If a task on the to do list is not completed it is added to the next day's to do list. As tasks are moved, notifications are provided to the care recipient, the care giver, and any relevant third parties. Personal preferences are also stored. The personal preferences are entered and compiled over time by use. Preferences include eating habits, dressing preference, washing/bathing habits, religious background, functional ability, continence level, interests, hobbies, and the like.

Given the devices interface, there is easy access to the care recipient's medicine list. Preferably, touching the name of the medicine provides relevant information about the medicine, dosage, side effects, appearance, and the like.

The device interface also provides easy access to emergency contacts. Preferably, the emergency contacts can be accessed through voice or touch. In fact, the interface for the device should be both touch compatible and voice compatible. The list of emergency medical information, which includes name, address, phone, notify emergency—name/phone #, family physician name, phone, date of birth, blood type, drug allergies, other allergies, heart history i.e. Pacemaker, contact lenses, epilepsy, medication, dosage, diabetes, medication/dosage, other medication, insurance company name, id number and policy number should be easily accessed. In one embodiment, emergency caregivers, police officers, or the like can access this information without a password. When accessing the insurance information, users can download a picture of the identification card with provider information, track bills paid, and those that remain unpaid. The system also has the ability to interact with electronic health record (HER) systems, which includes the ability to provide a patient and a provider with mobile access to health records system or the ability to view or download the users EHR to facilitate general health information management and record keeping.

In a preferred embodiment, the application or device supports continuity of care record (CCR) format for personal medical record transmission between systems, i.e., Google health or Microsoft health vault. Records can be sent and imported to the device easily.

The application or device preferably also stores a history of blood sugar, weight, blood pressure levels based on a “normalized” scale. Preferably, the application or device links with blood pressure monitors, blood glucose monitors, and the like to automatically import this data. Once the data is present, a tool is provided to analyze the data to log, track, or trend their occurrences or measurements for blood pressure, drug intake time, daily routine and share the information with a caregiver or circle of care.

The application or device can also provide an exercise reminder and the ability to store date, time, type of exercise, length of time, and notes.

In one embodiment, care recipients can designate a circle of care. This circle of care is established by the care recipient and designates who they want to share their personal information or personal directives with. They can also designate or assign tasks to specific people. However, for care recipients having advanced degenerative diseases, the designation can be done by a third party. The circle of care allows the assigned individuals (care recipient, adult child, caregiver/family member) to be in direct communication throughout the day, organized, and on task. Given the scheduling component, there is the ability to check what was done/not done/remind me again and share information in real time data. If after a certain amount of reminders are given and no response is given and alert is sent to a designated person.

Given the communication abilities of the device or the application, it is possible to see the activities of care recipient and caregiver. Appointments can be added by assigned persons from the circle of care and assigned to caregivers if appropriate. Updates can be marked as done once completed. In one embodiment, tasks can be assigned to specific parties and can be viewed only by the assigned individuals. For example, a task can be assigned to paid caregiver and viewed by an adult child, not the care recipient.

Positive reinforcement is provided to validate the caregiver and let them know they make a difference and are valued. Messages such as “Good job! You did it 3 days in a row!” are regularly sent. Reinforcement is given when tasks are completed and achievements are tracked.

The application or device offers the ability to add doctor's appointments to the calendar automatically. The calendar can be imported and combined with the daily minder calendar.

For data entry, auto completion is offered. Auto completion eliminates the need to worry about not remembering a diagnosis or correct spelling. As words are entered, possible matches are displayed to the user.

The application can also send and receive reports. Tools are provided to generate a variety of reports regarding activity, medication, accidents, timeliness, scheduling, and the like. The reports or parts of a report can be emailed or send to a printer to create a hard copy.

In one embodiment, the application or device coordinates with a system in an assisted care facility or other recreation center. The in-facility activities that are scheduled for a given day are imported or selected individually to be added to the care recipient's schedule. In a similar manner, a menu for in-facility living can be accessed and a menu for the day, or week, can be selected. Preferably, those menu items that the care recipient is allergic to would be filtered prior to display or would not be selectable.

Preferably, the device and/or application would have customer service and support. In addition to automated help a customer service/helpline would be available. The support would include GPS location for lost phones and care recipients. In one embodiment, triangulation would be used for location purposes.

In one embodiment, prior to using the application or device, all of the users must view a simple to understand video demonstration video that would include a waiver of liability.

The device face has large print numerals for easy reading. The numerals are typically printed in black against a white background, although any high contrast combination is acceptable. The device bezel includes lighting elements that increase or decrease illumination of the device face. In a preferred embodiment, the illumination is varied based at least in part on data from light sensors. In this manner, the device face is illuminated to compensate for ambient lighting. In a preferred embodiment, the application modifies a smartphone display for a user's comfort.

A feature of the multipurpose device is a calendar function. In a preferred embodiment, the calendar links with a scheduling software on a personal computer such as Outlook or the like. In this manner, scheduled appointments, records, contact information, medication schedules, appointment reminders, and the like are programmed into the multipurpose device. The multipurpose device provides at least one of audible, visual, and tactile alerts based at least in part on the calendar. In a preferred embodiment, a strong vibration activates based on alarm settings, multiple timer reminders for such things as medication reminders, appointments, and the like, and a message display that displays preprogrammed messages. In a preferred embodiment, audible alerts are prerecorded or dubbed using a familiar voice.

For each mode of operation, the application provides user prompts. For example, in a doctor's office a series of adaptive questions are provided to the user to guide the office visit so that important details of the visit are not overlooked. These details can include questions about treatment, drug interaction, and the like. Additionally, other tasks can be accessed such as placing an order for a product. The prompts can then include such items as delivery times, installation, and the like.

In one embodiment, each item is selectable to bring the user to the next screen. For example, if a user has an appointment with a doctor at 10 a.m., the doctor's name can be selected. This will provide the user with the details of the appointment, including time and location. Further, the subprogram that includes the reason for the visit and the questions or topics to be addressed during the visit are presented. This subprogram also provides the relevant questions for given diagnoses or medical issues. Likewise, if the visit is to a library or store, a relevant series of questions or prompts are presented.

In a preferred embodiment, the device includes a medical alert feature. A caduceus signifies the availability of medical information relevant to the wearer of the device. In a preferred embodiment, a health care provider, such as a doctor, can transmit data including at least one of a diagnosis, a list of current medications, or a list of allergies for storage in the multipurpose device. In a preferred embodiment, the data is sent to the user and uploaded to the multipurpose device during a link operation with the personal computer. The data is preferably displayed via activation a button on the multipurpose device. In a preferred embodiment, the button for accessing the medical data is marked with a medical insignia such as a caduceus or the like.

The multipurpose device includes GPS functionality. The GPS functionality is, at a minimum, a locator beacon configured to recognize the location of the device and, if necessary broadcast the location of the multipurpose device. In a more complex system, the GPS provides mapping and routing functionality. The user is guided by at least one of visual cues and audible cues. In a preferred embodiment, the audible cues are dubbed using a familiar voice, for example, a family member's voice.

In a preferred embodiment, the GPS functionality is used to establish a perimeter or zone of travel for the user. Perimeters are preferably set via the computer and adjusted via the computer. The perimeter can be street addresses or square block radius. If the user strays beyond the established perimeter, the user is alerted via at least one of audio, visual, and tactile alarms. In one embodiment, the audible alarm is a prerecorded alert from a family member such as “you have gone too far, turn around, and come home.” As the user travels further from the established zone, the alerts are provided in a more intensified manner, i.e., louder, stronger vibration, brighter lights. In one embodiment, the GPS or locator function is provided by the smartphone's carrier via the cellular network.

In a preferred embodiment, an alert is sent to a friend, family, assigned relative, or service when the user gets close to or crosses a boundary. Once the user crosses the boundary a telephone functionality of the multipurpose device is activated to call the friend, family, assigned relative, or service could be initiated to confirm knowledge of the wearer's location. Alternatively, the friend, family, assigned relative, or service can call the multipurpose device. If further action is needed an ambulance is sent to the location of the user. In a preferred embodiment, if the user requires assistance, the telephone functionality is activated via a panic button on the multipurpose device. The multipurpose device preferably scrolls through a predetermined list of telephone numbers until a connection is made, i.e., a person answers the call. In another embodiment, in addition to, or instead of the telephone functionality, a walkie-talkie or push-to-talk feature is provided for direct contact with the user. A speaker and microphone located on the multipurpose device, similar to mobile phone speakers and microphones, are provided allowing the user to speak into the device. In one embodiment, the audio content is transmitted to a hearing aid or headset using RF transmission, IR transmission, Bluetooth, or the like.

In one embodiment, the multipurpose device includes a noise sensor. In this manner, the volume of the multipurpose device is automatically adjusted to account for ambient noise. The louder the surroundings, the louder the alerts or audible warnings become. Additionally, in one embodiment, in an environment with a high ambient noise level, a sensory or visual alarm is automatically activated.

A battery or a battery pack provides power for the multipurpose device. In one embodiment, energy is generated via a solar panel or motion. The battery can be chargeable via direct connection or inductive charging.

The device comprises large print numerals, preferably black numerals against a white background. A window is adapted to display messages, reminders, and the like. In an alternate embodiment, the device is digital and includes corresponding setting functionality. A bezel or faceplate includes light sources, using a light sensor, increases or decreases brightness indoors, and outdoors of the device face. Buttons provide walkie-talkie or push-to-talk functionality. In a preferred embodiment, a swivel head is adjustable to compensate for sun glare. In another embodiment, the various displays are covered with a polarized material to reduce glare.

The device band is secured with a safety lock. The safety lock can be opened via computer or a remote device. In a preferred embodiment, the device band includes a Medical Information Tag, similar to medical ID bracelet. In one embodiment, at least one button is a multifunction button. For example, the button acts as a Home Emergency Button, which, when activated, uses a GPS voice or visual cues to direct the user home.

A noise sensor grill or speaker is provided. Additionally, a display includes a battery indicator, a reception indicator, a message display screen, and a GPS display.

A main control panel including menu buttons to access a plurality of functions including alarm, timer reminders, programmed messages, calendar, address book, medical information, GPS selection of frequented locations (home, doctors, office, School etc.), and the like.

The GPS or locator feature uses a dubbed familiar or a relative's voice in lieu of a computer voice-record family or familiar voice into the GPS as an alert device i.e. using GPS data to alert the user “you've gone too far go to the next corner and turn left.” In this manner, a “familiar” voice tells the user the direction to take.

In one embodiment, the method is implemented as an application for a handheld computer or smartphone. In this embodiment, the application functions in a manner that provides reminders, scheduling, and the like.

The device preferably comprises a processor and a memory. The program described in more detail below is preferably stored in the memory. In one embodiment, a first portion of the data is stored locally and a portion of the data is stored on a central server. Additionally, portions of the program are stored on a central server. In one embodiment, once a diagnosis or item is entered into the system, elements related to the diagnosis or item are downloaded for use by the user. In this manner the program is interactive and can learn as time progresses.

In a preferred embodiment, the application provides one or more of the following features: contacts with prompt questions, pay bill reminder, bill history, insurance information, insurance bill history with follow up reminder, types of medical history, medical questions to ask doctor, on the go treatment log, medicine history, medicine list without details individual medicine list, supplements, emergency medical information, uploaded features, unique features, and a calendar.

In one embodiment, a contact list—contact titles prompts appropriate pre-reminders and post reminders. For example, reminders can be provided with text and graphics for such items as All about me—for family, friends, close friends, home; me: name; home address; home phone; cell phone; birthday—auto reminder; anniversary; high school name; college/year; family/pictures (husband, wife, mother, father, brother, sister, cousin, aunt, uncle, grandmother, grandfather, grandchild, son, daughter, etc.); name with picture; work phone, doctors (medical, psychological, therapist, veterinarian, trainer).

The application is preferably configured with modules that adapt as the user condition changes or declines. Caretaker modules also are configured to adapt.

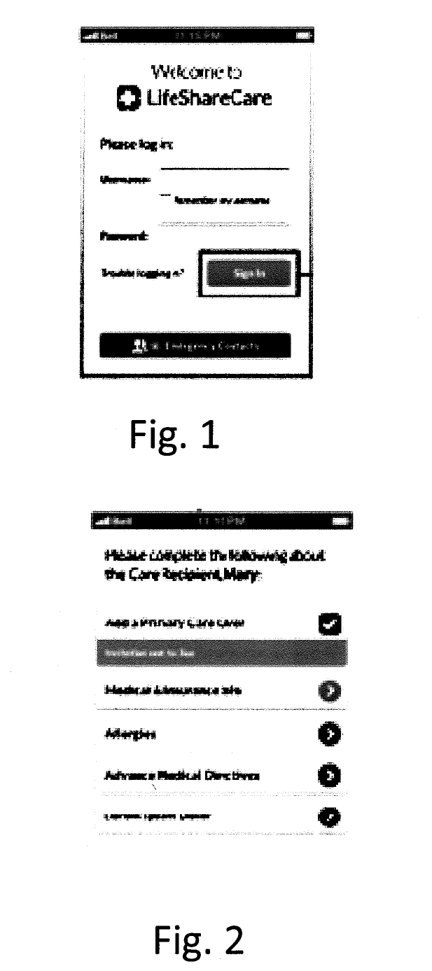

FIG. 1 is a login screen for an application. As shown, the user enters a username and password in designated fields. In one embodiment, for advanced patients, no log is is required.

FIG. 2 is a screen for inputting medical records. Once a user installs the application, they are presented with a medical history page. In one embodiment, the user is presented with a series of questions to establish a medical history.

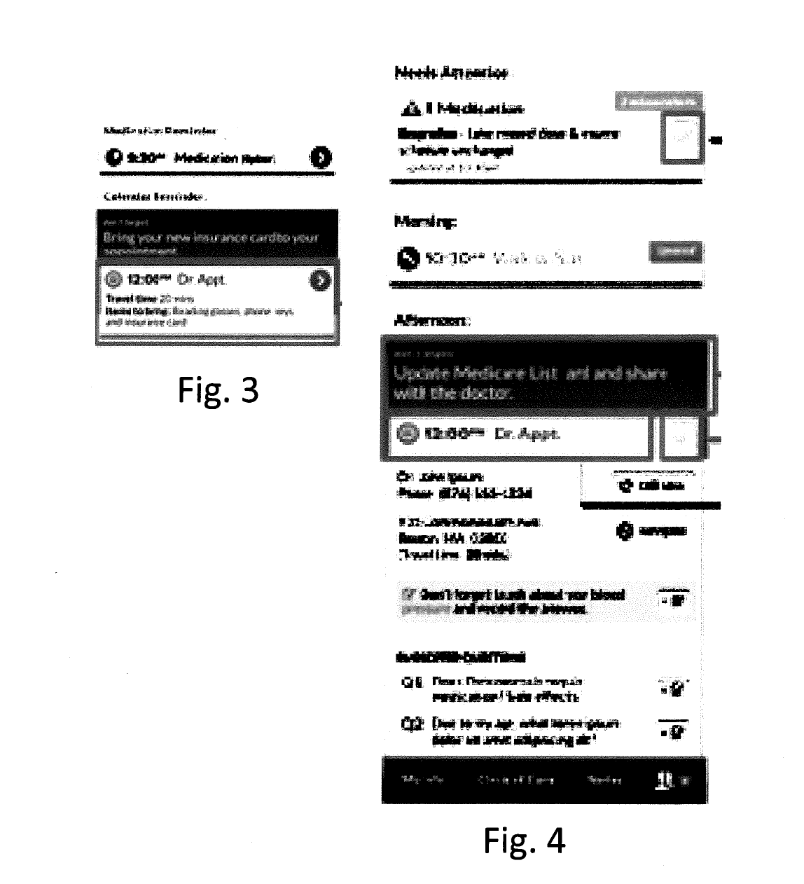

FIG. 3 is daily welcome screen with one appointment. As shown, the welcome screen presents a user with a daily summary. The user has two items for the day, medication at 9:30 and a doctor's appointment at 12:30. The welcome screen can present an entire day or only the next appointment or action item.

FIG. 4 is an expanded view of the appointment of FIG. 3. The medication task is shown with a verification. Preferably, the user or a caregiver is required to provide verification that a medication has been administered. Additionally, details are provided for the doctor's appointment. Depending on the patient's diagnosis and prognosis, suggested questions are provided to prompt discussion regarding the condition with the medical practitioner.

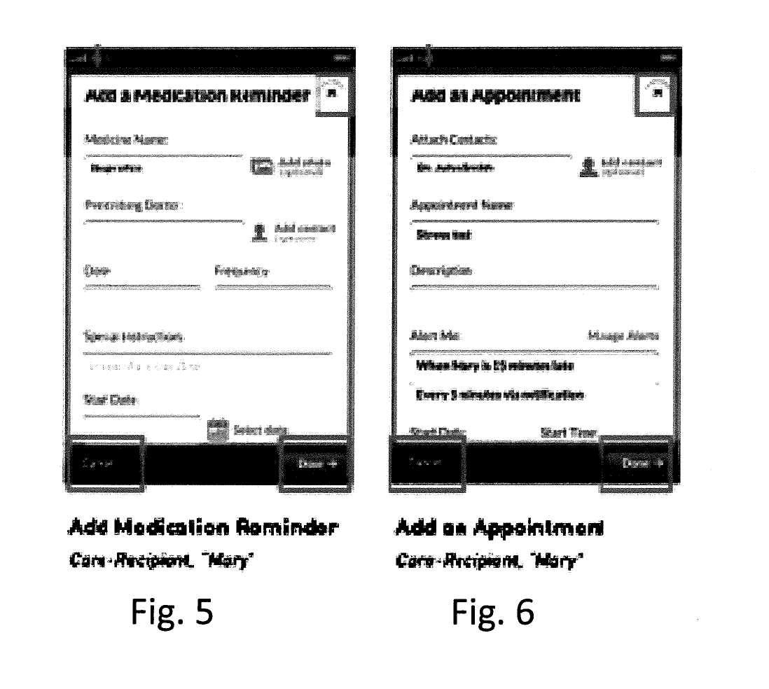

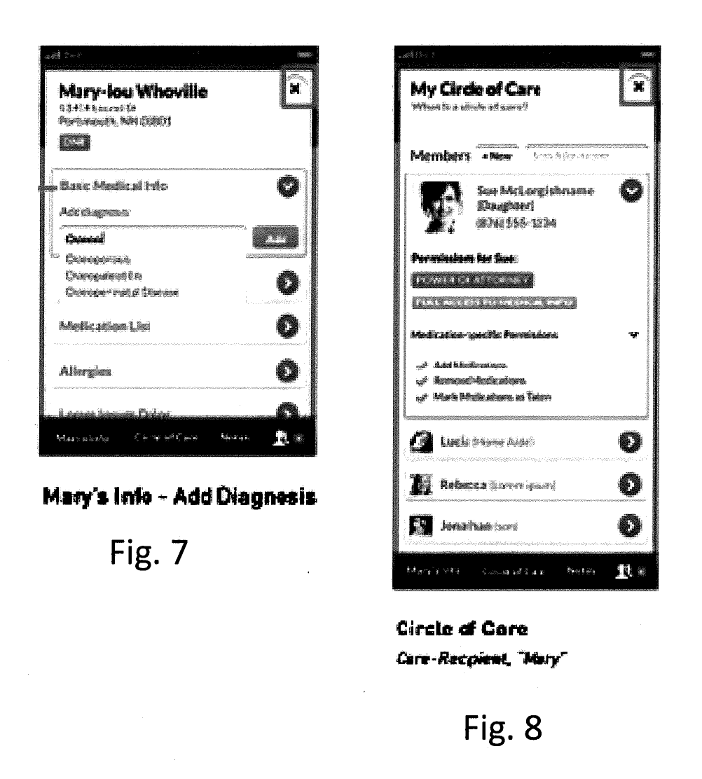

FIG. 5 is a medication reminder screen, FIG. 6 is a screen for adding an appointment, and FIG. 7 is a screen for adding a diagnosis. Each of these screen allows a user to enter additional medical information or schedule events. The medication and diagnosis fields are preferably used to verify medication compatibility and alert the user regarding suggested questions to initiate discussion with a medical professional.

FIG. 8 is a screen showing contacts and important records. As shown, a group of key contacts are provided for notification or emergency events. Additionally, relevant documents such as a power of attorney, health care proxy and do not resuscitate order (DNR) are available from this screen. This organized solution places relevant information for health care providers in one easily accessible location.

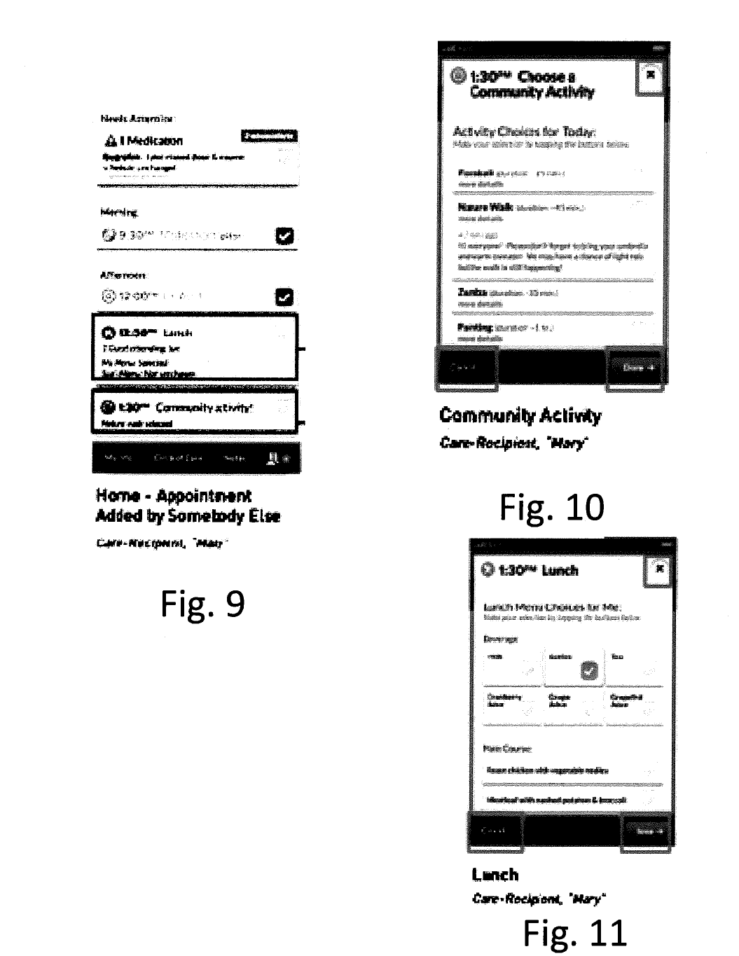

FIG. 9 is a screen showing appointments. Like the daily screen shown in FIG. 3, this screen present a daily overview. Selecting any displayed appointment or activity results in a detail screen being displayed. Detail screen are shown in FIGS. 10 and 11. Specifically, FIG. 10 is a screen showing appointment details and FIG. 11 is a screen showing appointment details. Each of these screens presents the user with details of the calendar event to assist the user in accomplishing the task.

In one embodiment, a Daily Activity Calendar Outline is provided to the user or caregiver. This allows for daily activity as a standing schedule vs. only putting in appointments and the like. The calendar will be set up by the Web Admin/user. A sample Schedule is presented below:

Web Administrator—Set up Daily Activity Calendar page
Day of the week: select Day
Choose activity and set Reminder

| Time: | Activity | Reminder Set |
|---|---|---|
| 6:00 | Set Alarm Time/Wake up | yes/no |
| 0:00 | Shower/Get Dressed | yes/no |
| 0:00 | Breakfast Time | yes/no |
| 0:00 | Medicine Reminder | yes/no |
| 0:00 | Exercise | yes/no |
| 0:00 | Feed pet | yes/no |
| 0:00 | Check emails/make phone calls/texts | yes/no |
| 0:00 | LEAVE from home-Reminder not to forget . . . | yes/no |
| 0:00 | Lunch | yes/no |
| 0:00 | Afternoon Medicine | yes/no |
| 0:00 | Dinner | yes/no |
| 0:00 | Bedtime Medicine | yes/no |
| 0:00 | Charge phone/Do not turn off phone | yes/no |

Add/Delete/change activity/save/delete

The Application preferably provides:
   1. Large print with high contrast
   2. Automatically increases or decreases brightness indoors and outdoors.
   3. Strong vibration, alarm settings, multiple timer reminders (meds, appts., etc.)—display messages (pre-programmed messages)
   4. Calendar set up via computer (similar to blackberry—i.e. Using Outlook) sends reminders of appt., records contact information, take medicine reminders, appointment reminders—sends a tone to the device with a vibration as a reminder tool. This feature can preferably be remotely activated by a caregiver
   5. Medical alert feature—located on outside of the device strap of wearer (similar to med id bracelet)
   6. Ability for doctor's office to e-mail current list of medications to e-mail address and then to send the info to the device and have it listed as a feature (i.e. Current medicines as of - - - ) button on side of device with medical insignia engraved on it. To be easily available in need of info. Or emergency.
   7. GPS or locator feature using a dubbed familiar or a relative's voice in lieu of a computer voice-record family or familiar voice into the GPS as an alert device—i.e. Using a proximity sensor—“Joe you've gone too far go to the next corner and turn left” have GPS “familiar” voice tell them the direction to take. Perimeters of a square block radius could be set via the computer allowing the wearer to travel within those perimeters. They could be adjusted via the computer. The perimeters could be set as street addresses or square block radius. As person gets further away from boundary the voice becomes more intensified. An immediate alert is sent to family or assigned relative when the device wearer gets close to a boundary. If the wearer bypasses the boundary a call from lifeline could be received by the relative to confirm knowledge of the wearer's location. If further action is needed lifeline will send out an ambulance to the location of the device wearer.
   8. Life-line button feature—connected to lifeline in the event of an emergency. Button will be easily accessible and visible.
   9. Voice tone will have a noise sensor to adjust volume depending on surroundings.
   10. Record your own audio alert (using familiar voice). Select which audio alert from choices on simplified and limited menu screen. I.e. You have an appointment, return home (have a GPS selection of locations i.e. Home, doctor's office, school, etc.) to have GPS guide you towards location using the familiar voice. Menu icon button.
   11. Ability to transmit voice of device into hearing aid or blue tooth
   12. Cannot be turned on/off without a code.
MILD EXAMPLE for a user that is high functioning—very early memory loss, premenopausal/menopausal, ADD, parents living long distance away
VOICE/Bell/Vibrator
   6:30 AM “Time to get up ______, today is Monday, Jan. 1, 2000.”(PAUSE) THEN VOICE. You have 3.5 hours before your first appointment at 10 AM with Dr. Smith.
   “The weather for today, Monday, Jan. 1, 2000 is ______ i.e. hot 80 degrees outside. Don't forget to wear a hat, sunglasses, suntan lotion”.
   *Reminder: don't forget to take a sweater for air conditioned areas. (BELL/VIBRATION)
   Repeat? If yes, repeat orientation, if no (PAUSE)—orientation will close. NOTES:
      Push notification to open application and set off alarm. (choose noise)
      Voice vibration text can be used
      White background black print
      Information Input:
   Web administrator: Login/password (caregiver or user)
   Enter user #1—Name, address etc.
   Alarm—Wake up time
   Create: Calendar for appointments or import calendar.
      Weather:
   30 degrees and below—prepare for snow—hat, gloves, boots, sweater, coat
   40 degrees and below—sweater, jacket, hat, gloves
   40-50 cold—jacket, gloves
   50-60 sunny—light jacket/sweater, sunglasses
   60-70 sunny—light jacket/sweater, sunglasses
   80+ suntan lotion, hat, sunglasses, sweater for air conditioning.
      Appropriate questions and information associated to contact or action are pre-entered. Many reminders are pre-entered.
      1^{st} appointment—from wake up time how much time till 1^{st} appointment or travel time needed.
      GPS travel time from location to appointment.
      Auto pop up—“you have the following summary of appointments” (voice and text)
      Can go back to previous page/Delete/save and minimize. Page is shown for 1-2 minutes and then closes.
      Changes made to task on phone application are automatically pushed to web administrator and changed on calendar, To Dos etc.
      Sync for Blackberry, Android, Outlook
      Changes to application can be made “on the go” from another designated mobile phone.
      Cab categorize To Dos according to location i.e., work, home, around the town
         Most important tasks go to top of list—flagged or tagged with keyword—immediate or urgent
         If done is chosen and no record selected—task is deleted.
         Auto spell correction
         Add to do list—add/delete
         Notes—can be added to or deleted
         Keywords:
         If choose Buy—go to shopping list
            Call—ask for reason for call?
            Pay—go to Bills—history
            Schedule—calendar/appointments—ask would you like to send an email for confirmation of appointment?/TO Do/choice of scheduling a standing appointment
            Goto—address/phone #/distance to appointment
         Take Meds—Medicine History—pill refill/reorder medicine
         Reminders or if not done—remind again (set amount of time)?
      Or go to next day To Do List.
Page can shrink to small window and open with touch for future referral.
(VOICE)/BELL/Text “Today, Monday, Jan. 1, 2000 you have the following appointments:”
   9 AM ______ address/phone (amount of time needed to get there)
   10 AM Dr. Smith (*memo) press memo to open
   (Show for 2 minutes and then close)
MILD—Example, high functioning—very early memory loss, premenopausal/menopausal, ADD, parents living long distance away
(BELL) To Do List for Me: for today Monday, Jan. 1, 2000
Important tasks (to be flagged or labeled immediate or urgent will float to the top of the list) also, can categorize to do's according to location: i.e. “work”, “home”, “around the town”. Put a badge on the tasks so they can be spotted on the road.
   1. Pay ______ bill (Due date ______) Done/Not Done/Remind again?/go to Next Day to Do List? If done, goes to Pay Bill History. (see set up)
   2. Call Mary—to discuss what? Set up *memo: Ask about Party. Done/Not done/Remind again?/Go to Next Day to Do List?/send email confirmation?
   3.—Buy soap. Add to Shopping List? Done/Not done/Remind again?/Go to Next Day to Do List?
   4. Schedule Beauty Parlor (auto give phone #/address) appointment for next month Done/Not Done/Remind again?/Go to Next Day to do List?
      (Question: Do you want to set up standing Beauty Parlor appointment?) Say “Add to appointments” give name/place/date/time/*memo
Option to Add/change items to Do List. Page can shrink to small window and opened with touch for further referral. If not done, send To Do List for Tuesday, Jan. 2, 2000 OR REMIND AGAIN (SET AMT. OF TIME))
Continued
MILD—Example high functioning—very early memory loss, premenopausal/menopausal, ADD, parents living long distance away

### Schedule for the Day

Monday, Jan. 1, 2000—before each event a bell/vibration will go off
7:00 AM EXERCISE—Choose type of workout: walk, run, gym other. Start timer—optional: take heart rate/End timer—optional: take heart rate ______ i.e. 30 min.
Done/Not Done/Record
Record (will show date, amount of time, enter type of exercise—go to exercise history ENTER)
8:00 AM (show picture of pill box) Take Morning Medicine (show name of specific med.) (Bell/vibration) Done/Not done (if done, send to Medicine Record for Medicine History) if not taken—remind again after 3 minutes—if not done, ask to remind again?—If forgotten to take medicine—say call doctor for further directions.
MILD EXAMPLE high functioning—very early memory loss, premenopausal/menopausal, ADD, parents living long distance away
Before each task a bell/vibration will go off
8:30 AM LEAVE for Dr. Smith check *memo you have 1 hour and 30 minutes before appointment begins.
   The word LEAVE will auto figure out how much time needed to get to destination or how much time before next appointment. LEAVE will also initiate the following Reminder:
   *Bell/Vibration Reminder: (pop up) did you take your keys, phone, briefcase, wallet, or pocketbook? Did you lock the door? Shut the lights and check the gas? Done/Not done/Remind me again? (Vibration/bell)
10:00 ARE Dr. Smith (read memo) click on/say open *memo (bell/vibration)—memo will remind to show medicine list or Mobile Medicine Log to Dr. Smith.
   10:15 AM—Reminder: Schedule next appointment Done/Not Done/Remind me again? If not done,
MILD EXAMPLE high functioning—very early memory loss, premenopausal/menopausal, ADD, parents living long distance away
   Send reminder to self to call Dr. Smith's office to set up appointment by email. (Information received by email goes to Web Administrator) To add to Calendar—sync calendar with email. Done/Not done/Remind I again? Reminder: Do you need your insurance information/Medical information? Insurance Information/Medical Information
And auto enter info into calendar of Administrator and appointment schedule of the user of the mobile phone) or enter voice record “set up appointment” with Dr. Smith.
Enter into calendar (voice activated) i.e. say “calendar”, “Enter Date”, “Enter time”, “Enter name”, “Enter address”, “Enter add memo”. (if needed), Go Back to make corrections Done/Not Done (once Done or Not Done is pressed—time is calculated for next appointment)

“Your next appointment is at 1:00 PM you now have time ______ before next appointment.”
MILD EXAMPLE high functioning—very early memory loss, premenopausal/menopausal, ADD, parents living long distance away
   Highlighted contacts set off pre and post reminders, related questions, and GPS information
   1:00 PM (bell) Meet Mary address/phone number for lunch at name of Restaurant ______ address/phone number—Done/Not done/Remind done/Remind me again?(Answer remind me in ½ hour)—reminder is scheduled
Your next appointment is at 2:00 PM. You now have ______ before next appointment. It takes 10 minutes to get to next destination.
   2:00 PM (bell) Beauty parlor—auto give address/phone #/haircut. Done/Not done/Remind again?/schedule standing appointment?
9:00 PM Take Evening Medicine (show specific medicine) Done/Not Done (send to Medicine record for the week) bell/vibration*Reminder: Don't forget to charge phone do not turn off phone. (Bell/buzzer) Done/Not Done
   NOTES: SCHEDULE OF THE DAY
   SHOW DATE: MONDAY, JANUARY . . .
   SHOW: EXERCISE REMINDER
   CHOOSE TYPE OF WORKOUT: WALK, RUN, GYM, OTHER
   START TIMER/END TIMER/HEART RATE
   EXERCISE RECORD: AMOUNT OF TIME, DATE, ACTUAL TIME AM OR PM
   DONE/NOT DONE
   SET UP: CHOOSE HOW MANY DAYS/WEEK
      CHOOSE DAY
      PREFERRED TIME TO BE REMINDED
   8:00 ARE—REMINDER TAKES MORNING MEDICINE
   If not taken—Remind again after 3 minutes if not done/ask to Remind again? Add note: if forgotten to take medicine consult doctor or follow medicine directions. If done, information goes automatically to Medicine Record:
   Show: Name of Medicine, Dose—(Edit—dosage should be editable in case dosage is missed/skipped or changed), Time taken, date, notes.
   Medicine List:
   Set up—*give option to change dosage or instructions.
   Name of Med/dose/time to be taken: morning, afternoon, evening, bedtime or 1×/day, 2×/day add other/date taken/# of pills dispensed in prescription/Purpose of Medicine: i.e. heart, sugar, water/Prescription/drug store name, phone, address/Doctor name, phone #, address
   Notes: with food/water/Send
   Send to Medical History
   # of Pills Left—when one week supply is left send Reminder to Reorder Medicine or ask to set reminder to Reorder to TO DO LIST and flag immediate>
   Choose amount of pills left to send reorder Reminder.—5 days/1 week/2 weeks or other
   “Reminder Alert” sends Reminder Alert to “Refill Pill Box” and Reorder Medicine to TO DO LIST and Flag immediate if 5 days or less left flag
   URGENT.
   Pill Box Setup:
   Days of week/Broken into Morning/Afternoon/evening/Bedtime
   Enter into slots medicines to be taken (should match actual pill box)
When touch Medicine name—set up for information.
*Limit # of medications per person. If more than 5 meds additional charge or Pro Version.
*memo: i.e. Dr. Smith *memo say or touch memo to remind to show Medicine List—Touch or open Medicine List—ask do you want to show Medicine history?
   MILD EXAMPLE high functioning—very early memory loss, premenopausal/menopausal, ADD, parents living long distance away
   Reminders:
   Standing Reminder for exercise/timer given/record
   Pay bill reminders
   Hearing Aid battery change/purchase
   Take Medicine reminders—Morning, Afternoon, Evening, and Bedtime—with specifications i.e. with/without food
   1, 2, or 3 week reminder to refill medicine pill box
   3 week reminder to reorder medicine
   Don't forget to take keys. Etc. given after “leave for appointment” is given
   Don't forget to charge phone
   Standing appointments—go automatically to appointment list
      High functioning CONT'D

### Additional Features:

Rolling method—information does not need to be requested by touching an icon but rather automatically is delivered by a timed delivery system. i.e., Application will open to the Orientation of the Day page—then followed after a time lag by an outline of just the day's appointments, followed by an additional time lag—the To Do List—which can be opened and referred back to at any time—and then followed by the Day's Schedule which includes appointments. This eliminates the need to navigate for icons. Voice to text will be used as well as the choice to text without Voice. In a preferred embodiment, an interactive voice command and prompt application is provided.

Auto spell correction for text errors i.e. mlik to milk—spelling is detected as it is written

White background with black large print

Audible pop-up alarms for tasks that are due soon.

Personalized Morning greeting

Weather with related suggested appropriate dress attire—don't forget to take . . .

### Features Continued.

The questions and information are already entered. No need to enter every reminder independently.

Option to Keep History of tasks or delete

Each Contact has questions reminders associated with the Contact and given at time of appointment.

Pre-Reminders—i.e. don't forget to show Medicine List. Timed (i.e. 15 minutes into the appointment receive a) Post Reminder: Don't forget to schedule your next appointment.

Emails sent with appointment information are entered automatically into calendar, appointments and to do list. All information with key words is synced into the different functions.

Information can be shared or changed with another mobile phone and inputted by the shared phone (i.e. caregiver, relative).

Changes can be made on the go!

Standing appointments can be set up as well.

To do's are categorized according to location i.e. work, home, around the town. A badge can be added to item to see the item on the road.

To do's can be labeled according to level of importance.—Flag it or Tag it or some other indicator

### Features Continued.

Separate sections of the to do List can be divided/Titled: To Do List for Me or To Do List for Caregiver or health monitor i.e. work, husband, son, daughter, mother, etc.

Most important tasks will float to the top of the list.

Changes made to task on the user phone can automatically be pushed to administrator phone and are changed in the coinciding calendar etc.

Sync for Blackberry, Android, Outlook

Amount of time calculated between appointments with amount of time needed for travel.

Shopping List—Standing daily/weekly/monthly list
Medicine List—Name of User, Allergies, Sex, DOB, current weight as of ______, Name of Med, Dosage, Frequency, Purpose of Medicine ______ Diabetes ______, Date Started, Date Ended.
Medicine history—with secured password—Name of Med, date prescribed, date started, Name of Dr, phone #, Pharmacy # and Prescription #, Dosage and Frequency/special instructions, # of pills dispensed, # of Refills, Dose and Date Last taken, Notes/Comments.
Supplement List and History
Refill Medicine Alert

Features Continued.
Refill Pill Box Alert
Optional: Mood Evaluation Module 1-10
Daily Chart for Sugar Count—Date, Level, Time Taken, Notes
Daily Chart for Weight—Diet Watch—Date, Weight, Time Taken, Calorie Count, Notes
Appointments can be set up by voice or text—automatically sent to calendar, schedule of the day
Important Medical Information with secured password
Insurance Information with secured password
Emergency Contacts
GPS—Navigation
Technical Assistance—Auto dial for technical support 24/7 U.S. Based customer service
help with setup, questions and guidance. Note: minutes are used for service while speaking with operator and for the length of any call they connect for you
Follow up list—next day To Do List
Entries into calendar can be entered by voice/text or web administrator or on the go from caregiver to user.

Features Continued.
All appointments sent by email from i.e. doctor's office to user email address will automatically be sent to calendar/appointments
GPS for lost phone
MODERATE EXAMPLE
MODERATE—(more advanced)
(Alarm will open phone to app.)
6:30 AM (Bell/Vibration/Animated figure/voice) “Wake up ______ Joe ______. It is 6:30 in the Morning and today is Monday, Jan. 1, 2000. Good-morning!”
______Repeat:
It is 6:30 AM time to wake up. (Voice and text)
Your first appointment is 9 AM with Dr. Smith you have two and half hours before your first appointment.
Voice/text/animation: The Weather forecast for (repeat day and date) is ______ i.e.
Cold 50-60 degrees. (show animated figure wearing appropriate clothes)
“Don't forget to take a”: (for example)
If 30 degrees and below: Then take jacket, hat, scar, boots, and sweater
If 40 degrees and below: then same
If 50 degrees and below: then jacket/sweater
If 60 degrees—then light jacket

More advanced continued:
70 degrees and above: suntan lotion, hat, sunglasses and sweater for air conditioning
Rain/chance of Rain—take umbrella and wear raincoat and boots Monday's (Date)
To Do List: (bell sound) pops up every 15 minutes (adjustable time) but available to be seen by touching To Do List box.
1. Call Mom (give phone #) dial/call Mom? Note: discuss ______ Done/Not Done
2. Pay Electric/Gas bill (due date ______) if done, goes to paid bill history, if not done, goes to To Do List Done/Not Done
3. Order medicine ______ pharmacist #______ prescription #______ Deliver to home (give address/phone number) Done/Not Done More advanced continued:
4. Shopping List—Buy hangars—(voice command) ADD to Shopping List—Buy hangars (check) Done/Not Done
(If no, go to To Do List for next day or remind later)
As each item is completed put into history of To Do List and delete off the list. History list remains for 2-3 days.
Voice/bell/text: Today you have the following 2 Appointments: (bell sound)
   9 AM—Dr. Smith * see memo
   10 AM daughter—Mary—coming to visit me—auto: phone number and address
Today's Schedule
7:30 Exercise—Reminder: take your sneakers, gym clothes. Done/Not Done
Type of exercise ______
Start time: ______
End time: ______

More advanced continued:
Set goal of 150 minutes/week recommended by national Institute for Health and American Diabetes Association
(picture of a clock to time routine—touch to begin/end)—touch Record
Optional Reminder: Take blood sugar level Enter Sugar Level/date/time
Optional Reminder: Take weight Enter Weight/date/time
   8:00 AM Did you have Breakfast? (Bell sound) Done/Not Done Optional: Diet tracking/Record
   Optional: can remind again in three minutes. Flashing: Reminder to eat before taking medication
   8:30 AM Voice/text/Bell “Don't forget to take your Morning Medicine(s)” (bell sound): show list of Meds for AM Done/Not Done (if not

More advanced continued:
done, bell will continue with vibration and pop up every 3 min.)—if done, send to Medicine Record for the week
8:40 AM (voice/text/bell) Time to Leave for 9 AM appt. with Dr. Smith see *memo
   (touch for directions/address/phone) (bell sound/vibration/text)—(voice) you have 20 minutes before appointment begins.
   Flashing Reminder: Don't forget to take: watch, keys, pocketbook/wallet, cellphone (bell sound/vibration) Lock the doors when you leave!
   9:00 AM—Dr. Smith (touch for directions/address/phone)—*memo: (flash memo with bell/vibration/voice—for questions to be asked) memos can be stored and replayed in doctor's office or replayed at home. i.e. Show list of meds to Dr. Smith. Done/Not done

More advanced continued:
See Insurance information? Enter security password ______
Follow up Reminders: Bell/vibration/text (9:30 AM)
   1. Did you schedule your next appointment? Enter into calendar
Touch Calendar Say “Enter” give name, date, time, (optional: add *memo) Done/Not Done (if not done continue, if no response remind again, in 3 minutes, if still no response enter into To Do List for next day.
   2. Do you need to Renew/Order medication?—show Drug Store name and phone number *Reminder: Delivery? Where to? home (address/phone number shows) Done/Not Done
More advanced continued:
10:00 AM—Meet Mary at home
12:00 PM Lunch time
1:00 PM Rest
1:45—Get ready for class (bell)
2:00 PM Class
   Optional Reminder: (pop up) drink 1 glass of water (bell) Done/Not Done
Optional Reminder: Time to go Home Reminder (picture of home)—voice activated i.e. GO Home (GPS Directions to home), home button (picture of house)
4:00 PM Take Afternoon Meds (specific names) (bell sound) show list of Afternoon Meds Done/Not Done if no, bell/vibration will continue every 3 minutes (send to medicine record for the week)

More advanced continued:
5:00 PM It is 5:00 PM in the Evening, Jan. 1, 2000 (orientation Optional: Reminder)
6:00 PM Dinner
9:00 PM Take Night time Meds (specific names) (bell sound) show list of Night time Meds Done/Not Done bell/vibration will cont. every 3 min.—(send to Medicine record for the week)
*Reminder (pop up) Don't forget to take out your hearing aids!!
*Reminder (pop up) charge phone Done/Not Done
   Available features:
   Schedule is shared by User and Caregiver changes can be made by voice or touch pad.
   Lock feature: to keep phone open when app in use.
   Phonebook/Addresses/voice activation phone dialing (call home)

More advanced continued
Help Button—call forwarded to designated Emergency Contact i.e. caregiver phone and lifeline
   Medicine List—broken into time or parts of the day
   Shopping List
   Remove Hearing Aid Reminder—Set bedtime with Reminder
   Hearing Aid Battery Change Reminder (every 2-3 days) entered on calendar.
   24/7 U.S. Based customer service Auto dial for technical support—help with setup, questions and guidance. Note: minutes are used for service while speaking with operator and for the length of any call they connect for you
   GPS for lost phone Secured by password
   Important Medical Information Reminder:
   Name and phone number
   Alert Info: i.e. diabetic
   Allergic Reaction (i.e. penicillin)
   Doctor's name and phone #
   Contact person and phone:
   Blood Type
   Birthdate
   Insurance Company
   Policy #
   Emergency Contact Info.—Emergency Info. button—(give #s of caregiver or relative—voice or touch activated—touch picture of relative or caregiver)
   GPS (navigation)
   Follow up list
   GPS locator for lost phone with loud detecting alarm sound overrides vibration—Button to press for lost phone

More advanced continued:

### Optional Reminders:

Hourly reminders—Day and Evening reminder (daily reminders)

More advanced continued:
Pay bills reminder (set on calendar)
Beauty Parlor/Barber Haircut/cut nails reminder (calendar)
All about me (pictures with names) (family photo album)
1, 2, or 3 week reminder to refill pill box (calendar)
2 or 3 week reminder to reorder medicine (calendar)
Time to go home reminder
Take Medicine reminder (see layout) should be flexible for anytime/able to delete yes/no if entered incorrectly
Take Blood Sugar Level—record/history
Take Weight—record/history
Go to bathroom

More advanced continued:
Time to leave—set amount of time (also pop up reminder: “don't forget to take your keys” . . . )
Hearing aid Battery Reminder (every 2-3 days) entered on Calendar
Charge cell phone reminder (directions to be given as to how to close application and view charge bars)
Show Free time slots (i.e. 10 Am-2 pm)
CAREGIVER
   6:00 AM Good Morning! Today is Monday, Jan. 1, 2000 Weather for today: Cold 50 degrees, cloudy, chance of snow flurries.
   6:15 AM Exercise—start timer—optional: take heart rate/end timer—Optional: take heart rate Done/Not Done Record Exercise
   6:45 AM Cook dinner, shopping list, laundry (for own home)
   To Do List for Monday:
      Shopping List—order groceries for week (see list—show picture of shopping basket) Done/Not Done
      Order Meds for user (see Medicine History) Done/Not Done
      Medicine Reminder—Refill Pill Box
      Call ______ why? ______ Done/Not Done
      Laundry Done/Not Done
   CAREGIVER
      Prepare Menu for week Done/Not Done (If no, then choice of later reminder or go to Follow up List)
      Follow up List for Jan. 1, 2000
      Call Mary re: party Done/Not Done/Delete/Remind me again in 15 minutes?
      (if no, then choice of reminder or Follow up List)
   You have the following appointments for Monday, Jan. 1, 2000:
      9 AM drop off
      10 AM Dr. Smith—(show) address/phone #
      2 PM - - -
      4 PM pick up at address - - - from - - - (give amount of traveling time)
   (* Daily reminder: clean up dishes, laundry, make beds, and prepare dinner (user home)
   CAREGIVER
   9:00 AM (BELL) Do laundry—Change Bedding, Cut nails, check menu, take out chicken to defrost
   9:15 AM (Bell) Reminder: Take weight/sugar level Make sure Meds were taken or give Morning Meds Done/Not Done Record
      *reminder: take extra set of clothes: pants, diaper, socks
   9:30 AM (BELL) leave for Dr. Smith
   b 10:00 AM (BELL) Dr. Smith—don't forget to update Medicine List. Done/Not Done Do you need to order Medicine? Yes/no if yes, Pharmacy name and phone #, delivery? If yes, give home address.
   10:30 AM Post Reminder: Did you schedule next appointment? Enter information: New Appointment: Name, Date, Time, Memo:
   11:00 AM Optional Reminder: Don't forget to drink a glass of water! Done/Not Done
   Reminder: Take Sugar level Done/Not Done Record 12:00 PM Prepare lunch, straighten up home
   Reminder: Refill Pill box for one month—check pill supply Done/Not Done
   3:30 PM (BELL) Leave to pick up
   4:00 PM (BELL) pick up
   4:30 PM (VIBRATE) check menu for Jan. 2 prepare dinner
   Reminder: Prepare Bedtime Meds
   5:00 PM—(BELL) pick up daughter from day care
   CAREGIVER
   Features:
   Able to share updates and on the go reminders with user.
   Orientation
   Shopping List: i.e. pads, detergent
   Phone Book
   To Do List
   Follow up list—move items from to do list to Follow up list—(for next day)
   Medical Reminders to email
   Medicine list
   Emergency Medical Information
   Emergency Contact Information Auto dial for technical support 24/7 U.S. Based customer service—help with setup, questions and guidance. Note: minutes are used for service while speaking with operator and for the length of any call they connect.
   GPS for lost phone
   CAREGIVER
   Reminders:
   Change bedding on Days: M, T, Wed, Th, Fri, Sat., Sun.
   Grooming—clip nails, tweeze, scissor, shave—set day of the week, 1-2×/week
   Make appointment for Beauty Parlor/Barber
   Enter Standing appointments
   Check hearing aid batteries/Schedule to reorder batteries
   Refill pill box
   Reorder Medicine
   Pack lunch
   Check Menu for ______
   Take extra set of clothes
   Bathroom Reminders for User
   Drink Water 2-3 glasses/day
   Check Blood Sugar/history
   Check Weight/history
   Take out hearing aids
Pet Schedule Reminder
ASSISTED LIVING
   (VOICE/BELL)
   Alarm opens application. Bell, voice, vibration and text and animated object.
   7:00 AM “Good Morning ______ It is 7:00 AM (in the morning). Today is Monday, Jan. 1, 2000.” Get up slowly!!
   The weather for today is sunny and cool. The temperature is 50 degrees. Don't forget to take a light jacket, sunglasses.
   (VIBRATION/Bell/Text)
      To do list for Monday, Jan. 1, 2000
         Call daughter (auto: address and phone number)
            Done/Not Done
         Reminder daughter to order medicine. Done/Not Done (Reminder is also sent to daughter to order medicines.)
         Call Dr. Smith for appt.—Ask: Do you need to bring anything with you to the appointment? If yes, set Reminder for Dr. Smith appointment.
            Done/Not Done
   ASSISTED LIVING
      Reminder Change hearing aid batteries Done/Not Done—

Reminder is also sent to Caregiver/relative
(If not done, reminder sent again every 3 min or To Do List for Tuesday, Jan. 2, 2000)
   The following are your appointments for Monday Jan. 1, 2000:
10:00 AM—Visit Mary and her children (auto: address and phone number)—leave at 9:45 AM
Today's Schedule
9:00 AM (BELL) Breakfast begins (click to see today's menu)
9:30 AM (BELL/VIBRATION/TEXT) Eat before you take Morning Medicine (name of specific med) Done/Not Done (if Not Done, then reminder every 3 min.—for 3 hours)
ASSISTED LIVING
   Today's Schedule continued:
   9:45Am (BELL) Leave for Mary's house (if name in phone book—auto show address and phone number) You have 15 minutes traveling time before appointment.
   10:00 AM (BELL) Visit Mary and her children.
   12:00 PM (BELL) Lunch (click for menu)
   After lunch: do you need to change your shirt?
   *Optional Reminder: (BELL) drink glass of water Done/Not Done
   1:00 PM (BELL) Rest
      Optional Reminder: (bell) drink glass of water Done/Not Done
   3:00 PM (BELL) Class (i.e. music)
ASSISTED LIVING
   4:00 PM (BELL/VIBRATION) Afternoon Medicine Reminder (specific name of medicine) Done/Not Done (if Not Done, then reminder every 1 min. for 3 hours) if yes—send to Medicine Record
   (BELL/VIBRATION) Evening Optional Reminder: “It is 5:00 PM in the Evening Jan. 1, 2000”
   6:00 PM (BELL) Dinner (click for menu)
   9:00 PM (BELL/VIBRATION) Take “Before Bedtime” Medicine Done/Not Done, if no response reminder every 1 minute for 3 hours if yes—send to Medicine Record for week
   (BELL/VIBRATION) Optional Reminders: Take out hearing aids, Drink water

Features:
Orientation
Weather with what to wear suggestion
Menu for the week—entered by Home and sent to iphones via e-mail to Menus category.
Calendar of activities at the Home for the week to be sent to smartphone via e-mail with 15 minute reminders.
Exercise Reminder—time exercise and record into history Reminder: to take sneakers
Medicine list
Medicine Reminders:—Take Medicine with or without any specifications, Order and Reorder Medicine, Refill pill box
Medicine History—Tracks history of medication taken—can be sent as Medical Log to Doctor

Shopping List
To Do List—if not done, go to To Do List for next day
Phone Book
Emergency Button
GPS—navigation—inside and outside of home—triangulation—Location of programs can be directed by GPS with voice directions.
GPS—Navigation Feature: for time of day boundaries—if beyond boundary an alert will be sent to caregiver/relative. If no response an emergency response will occur. A 24/7 customer service such as Alzheimer Association Comfort Zone can be subscribed to. (Recommended to register with the Alzheimer Association Safe Return Program)
Emergency Medical Information
Emergency Contact Information
All About Me (pictures with names)—tap picture says name
GPS for lost phone
ASSISTED LIVING
“HELP”!! (voice command) autodial to caregiver/relative if no response to Emergency Service.
Auto dial for technical support 24/7 U.S. Based customer service—help with setup, questions and guidance. Note: minutes are used for service while speaking with operator and for the length of any call they connect for you.
Reminders:
Change shirt after meal
Reorder Medicine (can set for specific interval)
Charge phone
Take out hearing aids/Reorder batteries
To take medicine
Orientation of day reminder—i.e. Evening Reminder “Good Evening it is Monday, Jan. 1, 2000 it is 5:00 pm”
ASSISTED LIVING
Schedule Beauty Parlor/Barber appointment
   *the assisted living application can be programmed by the home. The menus, daily activity schedule can be sent to the specific e-mail addresses of the users of the phone in the home containing the application.
   Optional Reminders:
Self check test: What month is it?
   Where do you live?
      What is your Birthday?
         Name of husband/wife or how many children do you have?
   CONTACT LIST
OUTLINE OF LISTED FEATURES:
   CONTACTS WITH PROMPT QUESTIONS
   PAY BILL REMINDER
   BILL HISTORY
   INSURANCE INFORMATION
   INSURANCE BILL HISTORY WITH FOLLOW UP REMINDER
   TYPES OF MEDICAL HISTORY
   MEDICAL QUESTIONS TO ASK DOCTOR
   ON THE GO MEDICINE TREATMENT LOG
   MEDICINE HISTORY
   LIST OF CURRENT MEDICINES
   SUPPLEMENTS
   INSURANCE INFORMATION
   EMERGENCY MEDICAL INFORMATION
   UPLOADED FEATURES
   UNIQUE FEATURES
CALENDAR CONTACT LIST—contact titles prompt appropriate pre reminder and post reminders.
ALL ABOUT ME—FOR FAMILY, FRIENDS, CLOSE FRIENDS
HOME;
ME:
NAME
HOME ADDRESS
HOME PHONE
CELL PHONE
BIRTHDAY—AUTO REMINDER
ANNIVERSARY
HIGH SCHOOL NAME
COLLEGE/YEAR
FAMILY/PICTURE:
HUSBAND, WIFE, MOTHER, FATHER, BROTHER, SISTER, COUSIN, AUNT, UNCLE, GRANDMOTHER, GRANDFATHER, GRANDCHILD, GRANDAUGHTER, GRAND SON, SON, DAUGHTER
NAME:/PICTURE
HOME PHONE:
WORK PHONE:
CELL:
ADDRESS:
BIRTHDAY: AUTO REMINDER
ANNIVERSARY:
PICTURE:
FRIENDS NAME/PICTURE
HOME ADDRESS
HOME PHONE
CELL PHONE
BIRTHDAY—AUTO REMINDER
ANNIVERSARY
HIGH SCHOOL NAME
COLLEGE/YEAR
DOCTORS:
(MEDICAL—PRIMARY PHYSICIAN, SPECIALTY PHYSICIAN, PSYCHOLOGICAL, THERAPIST, VETERINARIAN, TRAINER)
SPECIALTY:
TITLE:
NAME:
HOME PHONE:
WORK PHONE:
EMERGENCY CONTACT PHONE:
CELL PHONE:
EMAIL:
WORK ADDRESS:
Questions to ask or reminders:
Primary or Specialty physician—Pre-Reminder: Do you need to bring sneakers or exercise clothes? Yes/no? if yes, Done/Not Done/Remind me again? Post-Reminder: Does the Doctor need to review your List of Current Medicines ? yes/no? If yes, touch to open List of Current Medicines, any changes? Yes/no? If yes, ask Doctor to send email to home or caregiver with changes? Post-Reminder Do you need to schedule another appointment? If yes, ask Doctor's office to email information to your email or go to calendar and Do you need your Insurance information? if yes, go to Insurance Information. Done/Not Done/Remind me again?
Physical Therapist—Pre-Reminder: Do you need to bring change of clothes/sneakers? If yes, Done/Not Done/Remind me again?,
Post-Reminders: Do you need to schedule the next appointment? If yes, go to calendar, ask to send email or enter via voice. Do you ask for a copy of the invoice? Do you need your insurance information? If yes, touch Insurance information.
Speech Therapist—Pre-Reminders: Do you need to bring your speech exercise toys? Yes/no, if yes, Done/Not Done/Remind me again? Post-Reminders: Do you need to schedule another appointment? Yes/no? if yes, go to calendar—ask to send appointment information to email address. Do you need a copy of the invoice? If yes, ask to send copy to email address. Done/Not Done/Remind me again?
Orthodontist—Pre-Reminder: do you need to bring your retainer? Yes/no. If yes, Done/Not Done/Remind me again? Post-Reminder: Did you schedule next appt.? Done/Not Done/Remind me again? Do you need your Dental Insurance information? Yes/No if yes, go to insurance information.
Trainer—Pre-Reminder: Don't forget gym clothes! Done/Not done/Remind me again? Post-Reminder: Do you need to schedule another appointment? Yes/no, if yes, go to Calendar enter information by voice.

Specialist Doctors—Pop up Pre-Reminder: Optional: Would you like to see a List of questions to ask Doctor re: enter name of Diagnosis ______ yes/no if yes, go to questions re: Alzheimer, Arthritis, Breast Cancer, Chronic Pain, COPD, Coronary Heart Disease., Depression, Diabetes, Gout, High Blood Pressure, High Cholesterol, HIV/AIDS if no, close page. Post-Reminder: After half hour of appointment pop up, Do you need to update Current Medicine List? If yes, touch Medicine List. Do you need to schedule another appointment? If yes, go to calendar ask to send appointment to email. Do you need your insurance information?Psychologist—Post-Reminder: Do you need to schedule another appointment? Yes/no? if yes, go to calendar, enter info. by voice. Do you need your insurance information? Yes/no if yes, touch insurance information. Do you need a copy of the invoice? Yes/no? if yes, Done/Not Done/Remind me again? Veterinarian—Pre-Reminders: Do you need to bring a sample of feces or insect with you? Yes/no? if yes, Done/Not Done/Remind me again? If no, close. Post-Reminders: Do you need your pet insurance information? Yes/no? if yes, touch Pet insurance information. Do you need a copy of the invoice? Yes/no? if yes, Done/Not Done/Remind me again? STORES: PHARMACY (AKA DRUG STORE (see pharmacy), BEAUTY PARLOR, BARBER SHOP, GROCERY STORE, CLEANERS,)
NAME:
PHONE:
EMAIL:
ADDRESS:
Questions to ask or reminders:
Grocery Store—Do you want to set up a Reminder to place a grocery shopping order? Day/Every week/Every other Week? Yes/no? Do you want to place an order? Yes/no if yes, go to shopping list
Beauty Parlor—Do you need to bring any special conditioners/shampoo?
Barber Shop—Pre-Reminder: Do you need to schedule an appointment? Yes/no, if yes, go to calendar. Set Post—Reminder Would you like to set up another appointment for next month or a standing appointment? yes/no, if yes, go to calendar, enter info. via voice Done/Not Done/Remind me again?
TYPE OF STORE: PHARMACY/DRUG STORE MEDICINE/DRUGS
NAME: BUCKLEY'S DRUG STORE
PHONE:
WORK:
CELL:
EMAIL:
ADDRESS:
FAX:
NAME OF PHARMACIST:
Delivery information: Deliver to:
Key Words: Give Reminder to Order Prescription/Order Medicine—Give command go to Medicine List—Go to Name of Medicine automatically goes to Medicine Log. Choose Reorder Medicine yes/no, if yes, auto send email to Drug Store for reorder. Email will contain information on Medicine Log with instructions for delivery or no delivery. Or Call Drug Store (touch) keep Medicine Log opened Pre-reminder: Ask do you want to reorder Prescription now? Yes/No? if yes, Do you want the medicines delivered? If yes, Deliver to indicated location? Yes/no, if yes, Done/Not Done if no, Where do you want the Medicine delivered? Give information. Post-Reminder: Do you need to buy anything else? Yes/no? if yes, enter information on email or by voice. Do you need your insurance information? (touch insurance information)
SERVICES: HANDYMAN, TAXI, CAR SERVICE, CABLE COMPANY, TELEPHONE, GAS AND ELECTRIC, ELECTRICIAN, PLUMBER, COMPUTER ASSISTANCE, WATER COMPANY, REPAIRMAN, HOUSEKEEPER
NAME:
PHONE:
ADDRESS:
WORK:
CELL:
EMAIL:
FAX:
Housekeeper: Pre-Reminder: Don't forget to: Give choice to choose from: i.e. ______ laundry, make beds, clean silver, garbage, empty dish washer, dust, mop the floors etc. other
Do they need any supplies?: i.e. laundry detergent, cleansers yes/no if yes, go to shopping list
Reminder: Did you leave for money to pay housekeeper?: yes/no? Done/Not Done/Remind me again
Reminder: Leave a note: Did you need to leave a reminder note for the housekeeper? Yes/no? if yes, Done/Not Done/Remind me again?
Handyman/Repairman What needs to be fixed? Any special instructions? Did you make an appointment?—auto to calendar, How are you paying? Did you leave money?
TEACHERS/TUTORS/COACHES:
Pre-Reminder: Don't forget to bring your books/homework/assignment? Do you need to bring a check or money to pay for session? Yes/no? Post Reminder: Did you schedule your next lesson? yes/no? Enter calendar. Did you pay for the session? If yes, do you need a receipt? Yes/no? if yes, Done/Not Done/Remind me again? Notes:
TITLE:
NAME:
PHONE:
WORK:
CELL:
EMAIL:
ADDRESS:
FAX:
ENTERTAINMENT: (RESTAURANTS, THEATRE, BOWLING, ICE-SKATING MUSEUMS ETC.)
NAME:
PHONE:
CELL:
WORK:
ADDRESS:
FAX:
EMAIL:
Restaurant: Pre-Reminder: Did you make a reservation? Yes/no? Done/Not Done/Remind me again? Go to calendar?
Theatre: Pre-Reminder: Do you need to purchase tickets? Enter into Calendar. If picking up tickets at theatre, send Reminder to pick up tickets at ticket window and bring credit card. Enter into Calendar? Yes/no? Done/Not Done/Remind me again? if yes, send Reminder to leave for Theatre at x time based on time of performance. Done/Not Done/Remind me again?TRAVEL:
(AIRPORT, TRAVEL AGENT, PASSPORT BUREAU, HOTEL)
NAME:
PHONE:
ADDRESS:
WORK:
CELL:
FAX:
EMAIL:
Pre-Reminders: Do you need to make a hotel reservation? Yes/no? Enter into Calendar departure date/return date/hotel information/flight time? Yes/no? Done/Not Done/Remind me again? Are you traveling International? Did you check your passport for expiration date? Yes/no? Done/Not Done/Remind me again? Did you book a flight? Did you print your tickets/take a copy/put them in a safe location? Yes/no? Done/Not Done/Remind me again? Send Reminder on date of Departure to take passports and tickets—make a note where tickets are located. Send Reminder to confirm flight? If yes, set Reminder to call Airline day before flight. Do you need to make arrangements for a pet/child? Do you need a Reminder? Yes/no? if yes, go to calendar.
EMERGENCY: (enter phone numbers)—RESPOND TO “EMERGENCY” CALL GENERAL DOCTOR'S NAME—DIAL EMERGENCY PHONE NUMBER AUTOMATICALLY
911, AMBULANCE SERVICE. LIFELINE, FIRE, POLICE, GAS AND ELECTRIC—Call ______ # GO TO EMERGENCY INFORMATION. BUSINESS CONTACTS: i.e. Lawyer, Accountant, co-worker, other RELIGIOUS AFFILIATION: CLERGY i.e. Rabbi, Priest, other
Second Home Information: CARETAKER, HANDYMAN, ELECTRICIAN, other
Pay bills—Don't forget to pay (type of bill) ______
Set up to include when would you like a Reminder? Months, weeks, days, same day, Urgent!
Tax Bill—give due Date—set up Reminder for 2 month, 1 month, 1 week, 5 days, 3 days, 1 day, Urgent!—if done, go to pay bill history—enter date, ask type of payment made, enter amount paid—press enter to record.
Utility Bill—give due Date—set up Reminder if done, go to pay bill history—auto date, ask type of payment made i.e. check, money order, enter amount paid—press enter to record Utility Bill
Phone Bill/Cell phone—give due Date—set up Reminder if done, go to pay bill history—auto date, ask type of payment made, enter amount paid—press enter to record
Car Loan Bill—give due Date—set up Reminder go to pay bill history—auto date, ask type of payment made, enter amount paid—press enter to record
Mortgage Bill—same
Rent—same

### Auto Bill Reminder

Reminder: 3,2,1 weeks, 3 days, actual due date, current date/how many days left till due ______ Flashing Reminder when one week left.
Auto set up for utility bills, taxes, credit card, mortgage, other Reminder: 3,2,1 weeks, 3 days, actual due date, current date/how many days left till due Flashing Reminder when one week left.
If not paid: go to (flag) Urgent! (Bell, vibration, Text)—Remind me again in 15 Minutes. If paid, go to Bill History.

### Pay Bill History Setup:

Setup: Bill Reminder
Type of Bill ______
Account #______
Multiple payments: set up payment schedule—How many payments: ______ 1^{st} payment due: ______ 2^{nd} payment due: ______
Due Date ______ Set Reminder: weeks 3,2,1 Paid/Not Paid
   If not paid go to Reminder
   If Paid go to Bill History
   Due date adjustment ______ Type of Bill ______ Enter ______ send Reminder

### Bill History

Type of Bill Amount Due Date Date Paid Type of Payment i.e. Credit Card/check
SECURED PASSWORD

### Insurance Bills:

Do you need to submit Bill for Insurance? If yes, then go to
Set up for Insurance Information:
Name of Insurance Carrier:
Member Phone number:
Medical Claim Address:
Set up for Insurance Information cont'd.
Medical ID Number:
Group Number:
Member Name:
Prescription # of RXBIN, RX Group, RX membership ID #:
Name of Insured:
Address:
Date of Birth:
Social Security Number:
Name of Employer:

### Secondary Insurance Information:

Name of Secondary Insurance Co.
Address of Secondary Insurance Co.
Identification #
Contact Phone #

### Insurance Bill History

Go to Insurance Bill History—go to name of patient—go to service date—auto give pertinent information
Name of Patient:
Date of Service:
Name of Provider of Service:
Type of Treatment:
Amount of Bill paid:
Date Bill submitted to Insurance Carrier:
Name of Insurance Carrier bill submitted to:
Set up: If Bill has not been paid marked as: Bill Outstanding Ability to add note or Memo to Bill Outstanding to follow up on bill.
Notes:
Send Follow up Reminder: Bills outstanding (for bills or response not received by 3 months), 2 weeks, one month, two months? Set up Reminder. Done/Not Done if Bill paid, Go to Record Bill History.

### Types of Medical History

Weight History—set Reminder? Day ______ Time ______ Done/Not Done
(Optional: information can be transferred into graph form)
Record of Meal: ______ i.e. Breakfast, Lunch, Dinner, Snack
Date/Time: ______
Weight: ______ Change +/−______
SUGAR CONTENT:
CALORIE CONTENT:
Notes and Side Effects:
Done/Not Done/Remind me again
Sugar Count History: Date Time Level Change +/− Record (information can be transferred into graph form) if quantified (high or low) value
Set up graph according to frequency SELECT: Daily/every other day/every third day/weekly/monthly/yearly/as needed
REMINDER: SUGAR CHECK—CAN SET TIMER REMINDER FOR AMOUNT OF TIME TILL NEXT TEST. I.E. 4 HOURS AFTER LUNCH OR STANDING SUGAR COUNT REMINDER Done/Not Done/Remind me again if done, send information to Sugar Count History.
REMINDER: ENTER INFORMATION INTO SUGAR COUNT HISTORY EACH TIME TEST IS GIVEN. Done/Not Done
Blood Pressure History—Date Level Change +/− Record Blood Pressure set Reminder? (information can be transferred into graph form)
Exercise History—Time start AM/PM/Heart Rate start/Time ended AM/PM/Heart Rate end/choose Type of Exercise/TODAY'S DATE/Record Exercise History
   EXERCISE SET UP: CHOOSE HOW MANY DAYS/WEEK
      CHOOSE DAY
      PREFERRED TIME TO BE REMINDED
Medical Questions for Doctor Re: Alzheimer, Arthritis, Breast Cancer, Chronic Pain, COPD, Coronary Heart Disease, Depression, Diabetes, Gout, High Blood Pressure, High Cholesterol, HIV/AIDS
Pop up at Doctor's office: Questions for Doctor re: ______ name of diagnosis ______ (enter name of diagnosis)

### Questions for Doctor re: Alzheimer:

Here are a few questions you might want to ask:
1. What should I expect as the disease progresses?
2. What are my options for treatment? What are the side effects (if any) of each option?
3. Will I have to take medication for the rest of my life?
4. When might I expect the medications to take effect? What sort of change might I expect to experience?
5. Are there any medications I should avoid?
6. I feel scared and sad. Should I seek counselling?
7. Will I be able to continue to live on my own? When will I know to seek assistance?
8. Are there support services in my area that can assist my family and I in making decisions about my care and treatment?
9. What lifestyle changes should I make?
10 What is a clinical trial? Are there any clinical trials for Alzheimer's in my area?

### Questions for Doctor Re: Arthritis:

1. Can I exercise? If yes, what type of exercise would you recommend?
2. What non-prescription pain medication should I take?
3. What are the risks of taking aspirin or anti-inflammatories every day?
4. How can I protect myself from the side effects, like stomach trouble, of daily meds?
5. Do nutritional supplements, like glucosamine or shark cartilage, actually work? Would you recommend I take them?
6. How well can I expect to improve if I follow all the medical advice?
7. How does stress affect my arthritis?
8. What types of surgical solutions are available for my specific type of arthritis?
9. Does acupuncture or massage help arthritis pain?
10 Should I make changes to my diet?
11. What sort of progress can I expect to make if I follow all your recommendations?

### Questions for Doctor Re: Breast Cancer:

### Question About My Diagnosis

What type of breast cancer do I have?
What is the stage of my cancer?
Can you explain my pathology report to me? Can I have a copy for my records?
   Do I need any more tests?
Questions About My Treatment
What treatment options are available for me?
What are the benefits from each treatment you recommend? What are the side effects?
Will treatment cause menopause?
How will each treatment affect my daily life? Can I continue working?
How quickly do I need to make a decision about cancer treatment? What if I don't want cancer treatment?
What will cancer treatment cost? Does my insurance plan cover the tests and treatment you're recommending?
Should I seek a second opinion? Will my insurance cover it?
Will I need psychiatrist to calm down my anxiety and fears?

### Questions About My Lifestyle & Family

Do my children have an increased risk of developing breast cancer?
What will be my lifestyle change, especially in food as I will be having side effects?
Are there any brochures or other printed material that I can take with me? What websites or books do you recommend?
How will breast cancer affect my professional life?

### Questions for Doctor Re: Chronic Pain:

1. Is my pain related to a pre-existing condition?
2. Could pain medication help me?
3. What are the side effects of pain medications?
4. Can I take pain medications indefinitely or is there a risk of addiction?
5. What else can I do, aside from taking pain medication, to relieve my pain?
6. What sort of lifestyle changes can I make to relieve my pain?
7. Would regular exercise help to relieve my pain?
8. Would non-traditional therapies, such as massage, acupuncture or acupressure, and complementary and alternative medicine help relieve my pain?
9. Would nerve stimulation therapy help me?
10 Do I need to see a pain specialist? If so, which type?

### Questions for Doctor Re: Chronic Obstructive Pulmonary Disease

### Questions About My Diagnosis

What causes the COPD condition? Is it curable?
Do I have emphysema?
How do I know if I am going into respiratory failure?
What is my prognosis?
Does COPD affect my other vital organs?
Is lung cancer a possibility?
I hear that carbon monoxide is breathed in for the lung capacity test. Is that harmful?

### Questions About My Treatment

What medication will I be prescribed for my condition? What are the side effects of the drugs?
Will I need to carry an oxygen tank?
Will an inhaler and nebulizer help me?
Do I need special treatments at night? Do I need special training for my treatments? Where will that be done?
Would I be a candidate for a lung transplant?
Will the treatments be at the hospital or at home?
Is there a clinical trial that has newer treatments that I can participate in?

### Questions About My Lifestyle and Family

Is this hereditary? Are there special screening tests that my children should have?
If I stop smoking, can the condition be reversed?
Can you help me to stop smoking with medication or other methods?
Would nicotine replacement therapy affect my condition?
Can I go out with a portable oxygen tank? What precautions should I take?
Can I sleep lying flat or do I need a special bed?
Is there a special diet that would improve my condition or make it worse?
Should I get the flu or pneumonia vaccines?
Are there support groups that I can attend to discuss Chronic Obstructive Pulmonary Disease?
   Questions for Doctor Re: Coronary heart disease

### Questions to Ask

From your initial diagnosis throughout your treatment and care, you will have questions about your coronary heart disease. Below is a list of questions to discuss with your doctor so you can make informed decisions about your condition.

### Questions About My Diagnosis

What is causing my heart disease? Can I reverse it? Will it progress?
What is my long-term prognosis?
What symptoms should I be concerned about?
Will my condition improve if I stop smoking and/or using alcohol?

### Questions About My Treatment

Will I need surgery? What would happen if I didn't have it? What are the risks? What other treatment options are available?
Can I be treated with a special diet and medications?
What medications would treat me? What are their side effects?
Can I take this medication with the drugs that I am currently on?
Should I be taking a daily aspirin?

### Questions About My Lifestyle and Family

Is heart disease genetic?
What can my family do to decrease the risk of CHD?
What activities must I give up? Can I still have sex? Can I still work? Can I still drive?
What diet should I be on?
What exercise do you advise? Is there a rehabilitation program I should join?

### Questions for Doctor Re: Depression

### Questions to Ask

From your initial diagnosis throughout your treatment and care, you will have questions about your depression. Below is a list of helpful questions for you and your doctor to discuss so you can make informed decisions about your condition.

### Questions About My Diagnosis

What caused my depression?
Are there diagnostic tests that I should have?
Can I be cured or is this a life-long problem?
Will psychotherapy cure me of depression?

### Questions About My Treatment

What medication will I need to treat depression? Why was this medication chosen? Are there side effects?
How long will I need to take this medication before I see relief of symptoms?
Will I always have to take the medication?
Is there a treatment that I can have without drugs? Are there supplements, vitamins or herbs that can cure my depression?
What will happen if I don't take any treatment?
Will I get progressively worse?

### Questions About My Lifestyle and Family

Does this type of depression run in families?

Will my children develop this depression? What signs should I look for?
Is there a special diet that will help me?

Are there foods that I should avoid? Can I drink alcoholic beverages?
Will exercise relieve my depression?
Will antidepressants interfere with my sexual performance or sex drive?
Can I drive with antidepressants?

### Questions for Doctor Re: Diabetes

### Questions to Ask

From your initial diagnosis throughout your treatment and care, you will have questions about your diabetes. Below is a list of helpful questions for you and your doctor to discuss so you can make informed decisions about your condition.

### Questions About My Diagnosis

1. What is the difference between Type I and Type II Diabetes and which one do I have?
2. Are there other conditions associated or caused by diabetes?
3. What organs or body functions can be affected by diabetes?
4. What symptoms might I experience when my blood sugar is too high? Too low?

### Questions About My Treatment

1. Are there other specialists that I should see for routine care for my diabetes? How often will I need to go?
2. Will I be able to control my diabetes with diet and exercise or will I need insulin injections?
3. What is my dose and how do I inject the medicine? Are there side effects?
4. Are injections paid by my insurance?
5. How do I store my medication? Does it need refrigeration or is room temperature permissible? How do I dispose of used needles?
6. If my blood sugar tests in the normal range, do I still need to take my medication?

### Questions About My Lifestyle and Family

1. Is diabetes hereditary? How does this affect my children?
2. Can I get pregnant? Will I have infertility problems?
3. If I get pregnant, what risks will I face?
4. What type of diet will I need to be on?
5. Will my activity or daily routine be restricted? Can I participate in sports?
6. Can I travel by plane with my needles and syringes?

### Questions for Doctor Re: Gout

### Questions to Ask

From your initial diagnosis throughout your treatment and care, you will have questions about your gout.

Below is a list of helpful questions for you and your doctor to discuss so you can make informed decisions about your condition.

### Question About My Diagnosis

What causes gout?
Are there specific diagnostic tests that I need? How often should these tests be repeated?
What are the symptoms of gout? How long does a gout attack last?
Can I be cured of gout?
Are there other systems affected by gout?
What are the long-term risks of gout?

### Questions About My Treatment

What drugs treat gout?
How soon after starting medication can I expect relief of my symptoms?
Do I need to take the medication chronically or only when I experience an attack?
What are the side effects of the treatment?
Will other health problems develop if I don't treat gout?
Are there vitamins, herbs or supplements that prevent gout?

### Questions About My Lifestyle & Family

What foods or beverages should I avoid? Are there foods that trigger a gout attack?
Are there physical activities that I should avoid?
Can I work my normal job with this illness?
Is gout genetic? What can my family do to avoid it?
Is there an exercise plan that can keep me from having attacks?
Are there over the counter medications that can trigger a gout attack?

### Questions for Doctor Re: High Blood Pressure

### Questions to Ask

### Questions About My Diagnosis

Can hypertension be cured?
What medical conditions are associated with hypertension?
What is my prognosis?
Should I see a specialist?
How often should I be screened?

### Questions About My Treatment

Why did you choose this particular medication for me? Are there side-effects?
Are there generic equivalents? Are they as effective?
Will this medication interact with the other drugs that I am taking?
What are the risks of not taking medication?

### Questions About My Lifestyle and Family

Is hypertension genetic?
What foods should I avoid? Can I drink alcoholic beverages?
Is there a special diet or meal plan you recommend?
Will losing weight cure my hypertension? What is my ideal weight?
How much exercise should I do? Are there exercises I should avoid?
Will meditation and other alternative therapies lower my blood pressure?

### Questions for Doctor Re: High Cholesterol

### Questions About My Diagnosis

If I have a high triglyceride count and the total cholesterol number is normal, do I have a cholesterol problem?
What does a lipid panel include?
Are lipids and cholesterol the same?
Do I have blocked arteries or plaque formation already? What is my risk for heart disease?
How often should I have my cholesterol tested? What tests do I need?

### Questions About My Treatment

Is there a specialist for high cholesterol? Should I see one?
Do I need medication to lower my cholesterol? What are the side effects to these drugs?
Do I have to take the medication forever? Even if my values return to normal?
Can I lower cholesterol by taking supplements?
What risks do I have if I choose not to take medication?
Are there alternative therapies to lower my cholesterol?

### Questions About My Lifestyle and Family

Does this run in families? Will my children get it?
At what age should my children be tested?
Will a special diet decrease my cholesterol? Will you recommend one or should I consult with a nutritionist?
Are there foods that I should avoid? Should I give up alcohol?
How much weight loss would change my cholesterol numbers?
Is there exercise that I can do?

### Questions for Doctor Re: HIV/AIDS

### Questions to Ask Your Doctor About HIV/AIDS

From your initial diagnosis throughout your treatment and care, you will have questions about your HIV/AIDS. Below is a list of questions to discuss with your doctor so you can make informed decisions about your condition.

### Question About My HIV/AIDS Diagnosis

Is the diagnosis completely accurate? Is there a different medical condition it can be confused with?
Is there a difference in type of tests for HIV vs. AIDS? What type of testing do you do and why?
If the HIV test is negative, does it need to be repeated over time? If so, how long must I wait and how often should I be tested?
What are the symptoms that I may experience?
How severe is my condition and what is my prognosis? How long can I live with AIDS ?
How will my immune system be monitored?
What are the complications of AIDS? What organ systems are affected? How are they monitored?

### Questions About My HIV/AIDS Treatment

If I have been exposed to HIV, should I get preventative treatment to inhibit the infection? Is there one available?
What treatment do you recommend for me? What are the side effects of the drugs?
How long must I take the drugs before I see a result? Can the drugs cure me of AIDS?
Will I have to take the drugs forever or just for symptomatic relief? What happens if I don't take the drugs?
How will the treatment be monitored? How often will it be done?
What other tests do I need? How often do I need them?

### Questions About My Lifestyle & Family

Am I contagious to my family and friends? Should I avoid being in large crowds?
What should I do to prevent passing the virus to my family?
Is there exercise I can do to keep my immunity up?
Are there specific vitamins that I should take? Are there supplements or herbs that can help me?
Will I still be able to work? Are there activities that I should avoid?Will I ever be able to have children? Will my baby contract the disease? How would
Can I still have sex if it is protected? Can I still have deep passionate kisses without transmission?
List of Medications: (Lists all current medications being taken)
Name of Medicine: ______ Dosage: ______ Purpose: ______

### “On The Go” Medicine LOG

Secured page to be accessed with a password
Name of User:
Home Address:
ALLERGIES:
Blood Type:
Date of Last Tetanus Shot:
Sex:
Height: as of date:
Weight: as of date:
Date of Birth:
Major Illnesses/Surgeries:
Other Medical Conditions:
Name of Medicine: ______ GO TO Medicine History
ADD*MEMO? *Special Instructions: ______ i.e., with or without food, before/after meals, take with water
Purpose of Medication: ______
Emergency Contact (Name and phone #): ______
Primary Physician Phone #: ______
   Prescribing Doctor (Name and phone #): ______
Date of Prescription: ______
   Drug Store/phone 4/address/store hours ______
Drug Store Prescription Number # Number of Pills prescribed ______
Do you want to Reorder Medicine by email?
If yes, touch Reorder Medicine by email. Email automatically, to be sent to Drug Store with User name, Prescription #, with standing delivery instructions to deliver to home unless changed, home or cell phone number, prompt to ask to deliver to home address? If no, enter new address information.
Pill Counter ______ as of today's date ______ (show date)
*Add/Delete from Pill Counter: as of date ______ add ______ OR delete ______. Go to Medicine History enter date/time/dosage taken.
SET REORDER REMINDER for TO DO LIST WHEN ONE WEEK SUPPLY LEFT.
Start Date: ______
Date Ended: ______ enter into Medicine History DONE/Not Done
*DOSAGE: ______*(dosage entry needs to be flexible)
CHOOSE DAY: SUN, MON, TUES, WED, THURS, FRI, SAT
CHOOSE: MORNING ______ TIME ______
   AFTERNOON ______ TIME ______
   EVENING ______ TIME ______
   BEDTIME ______ TIME ______
DONE/NOT DONE/ADD/DELETE
Set REMINDER INFORMATION GOES TO DAILY CALENDAR.
ADD TO VISUAL PILL BOX? IF YES, INFORMATION WILL GO TO PILL BOX.
Number of prescription Refills: ______ if zero then auto send Reminder to TO DO LIST to “call” Doctor to refill (name of) Medicine. Done/Not Done/Remind me later? If Done., send to Medicine History—auto send update to Medicine List.
*If Missed taking Medication:
(Give option to send Reminder to take medication according to Doctor's instructions)—GIVE DISCLAIMER TO CHECK WITH DOCTOR FOR ANY CHANGE IN DOSAGE INSTRUCTIONS.
AUTO UPDATE OF VIRTUAL PILL BOX
*Memo: can make note how long supply lasted
**Can make adjustments when Medicine must be administered at a specific time and specific dosage—SET REMINDER for next time/dosage—ENTER amount to take. Done/Not Done
SET REMINDER TO REFILL PILL BOX DONE/NOT DONE/REMIND ME AGAIN SEND TO CALENDAR AND TO DO LIST SET UP FOR: 1/2/3/WEEKS/*allow flexibility for change of information. Add/Delete/Save information/Renew Existing Medication Information—give new start date
If Doctor made CHANGES TO MEDICINE OR PRESCRIPTION? YES/NO? ASK DOCTOR TO SEND UPDATE INFORMATION TO EMAIL ADDRESS. (AUTO SEND/UPDATE TO MEDICINE LOG AND MEDICINE LIST) OR, IF YES, GO TO MEDICINE LOG, ENTER UPDATE INFORMATION ENTER CHANGES ______ DONE/NOT DONE/DELETE/ADD/SAVE. SEND REMINDER TO CHANGE PILLS IN ACTUAL PILL BOX. AUTOMATICALLY ADD MEDICINE TO VIRTUAL PILL BOX. IF DONE, ASK, SCHEDULE MEDICINE REMINDER TO DO LIST? YES/NO? IF YES, SAME DAY, NEXT DAY ______ ENTER OR SAY DATE. AUTO SEND INFORMATION TO DO LIST—FLAG IMMEDIATE.
MEDICINE HISTORY: Name of Med/Date Prescribed/Name of Doctor/Doctor's # and address/Drug Store # and Prescription#/Start Date/*Dosage and Frequency/specific instructions #of pills dispensed/# of refills/Dose Last Date taken/SIDE EFFECTS/NOTES. If medicine not taken enter current date and doctor's instructions. If dosage changed permanently, go to Medicine Log enter stop date. Enter new information in Medicine Log with new start date.

(Information from Medicine LOG automatically goes to Medicine History when date ended is entered) PILL BOX
WHEN MEDICINE IS ADDED TO LIST AND QUESTION POPS UP “ADD TO PILL BOX?” IF YES, MEDICINE NAME WILL GO IN THE DAY SLOT AND TIME OF DAY TO BE TAKEN IN THE PILL BOX. BOX CAN BE SET UP FOR ONE WEEK/ONE MONTH
SUPPLY. BOX REFILL EACH TIME A MEDICINE REMINDER COMES UP TO TAKE MEDICATION AND DONE IS SELECTED THE PILL WILL BE REMOVED FROM PILL BOX. DEPENDING ON REQUEST FOR WHEN REMINDER IS NEEDED TO REFILL BOX AT END OF THE WEEK/MONTH A REFILL REMINDER WILL GO TO TO DO LIST. WHEN REFILL IS DONE THE PILL BOX WILL REFILL AS WELL.

Sun. Mon. Tues. Wed. Thurs. Fri. Sat.
Morning Aspirin Coumadin Aspirin,
   Coumadin aspirin Coumadin
NOON
EVENING
BEDTIME
SUPPLEMENTS: CAN BE ADDED TO PILL BOX AS WELL
Name of the Supplement
Date Prescribed
Start Date
What quantity comprises a dose
Dose Frequency—DAILY, EVERY OTHER DAY, EVERY 3^{RD} DAY, WEEKLY, MONTHLY, YEARLY, MORNING, NOON, EVENING, BEDTIME?—SET REMINDER. ADD TO PILL BOX?
How many pills in bottle?
End/Stop Date:
WOULD YOU LIKE A REMINDER TO BUY SUPPLEMENT? Yes/No? IF YES, REMINDER IS SENT TO DO LIST
Notes:
SUPPLEMENT HISTORY: Name of SUPPLEMENT
Date Prescribed Start Date Dosage Frequency End Date NOTES:
*MAXIMUM OF 10 SUPPLEMENTS, MEDS and DIETS AND TREATMENTS. More than 10 A Fee is charged.
OPTIONAL: EVALUATION MODULE—1-10 RATING TRACKS MOOD, SLEEP, HAPPY—VIOLENT
OPTIONAL: CALENDAR OF DIET, LIST DIETARY REQUIREMENTS, DAILY SUGAR COUNT—if quantified high or low value, NUMBER OF GLASSES OF WATER TO BE TAKEN DAILY
SECURED PAGE—USE PASSWORD
SET UP PASSWORD
PERSONAL INFORMATION:
NAME:
ADDRESS
BIRTHDATE
PLACE OF BIRTH
SOCIAL SECURITY #
BANK PASSWORD #
INSURANCE INFORMATION:
NAME OF INSURANCE CARRIER:
MEDICAL CLAIM ADDRESS:
MEMBER ID NUMBER:
GROUP NUMBER:
MEMBER NAME:
PRESCRIPTION # OR RX BIN, RX GRP RX MEMBERSHIP ID #
NAME OF INSURED:
DATE OF BIRTH
SECONDARY INSURANCE INFORMATION:
CARRIER:
ADDRESS:
PHONE NUMBER #
MEMBER ID NUMBER #
MEDICARE #
DATE CARD COMPLETED:
EMERGENCY MEDICAL INFORMATION
Name:
Address:
Phone Number:
DOB:
SS #
Blood Type:
RED ALERT INFORMATION: I.E. SEIZURE DISORDER, DIABETIC (Go to list of medications)
MAJOR ILLNESSES/SURGERIES:
OTHER MEDICAL CONDITIONS:
ALLERGIC REACTION: I.E. PENICILLIN
EMERGENCY DOCTOR:
PHONE #
ADDRESS #
   1. CONTACT PERSON NAME: PHONE NUMBER:
   2. CONTACT PERSON NAME PHONE NUMBER:
INSURANCE COMPANY:
NAME:
INSURED'S NAME:
ID #
CONTACT PHONE #
ADDRESS:
POLICY #
CLERGY #
RELATIVE #
FRIEND TO INFORM OF SITUATION: NAME AND NUMBER: ARE YOU AN ORGAN DONOR? YES/NO ______
DO YOU HAVE AN ADVANCE DIRECTIVE OR LIVING WILL? YES/NO HEALTHCARE POWER OF ATTORNEY: ______ UPLOADED FEATURES
   AUDIBLE ALARMS FOR TASKS THAT ARE DUE SOON
   SHARES REMINDERS AND UPDATES WITH ANOTHER MOBILE PHONE
   USER, CHANGES MADE ON THE GO
   VOICE, TEXT, EMAIL
   DISPLAYS SUMMARY OF WHAT YOU NEED RIGHT NOW
   HOW TO VIDEO WITH NARRATION
   ALL ABOUT ME—BIRTHDAY REMINDERS
   POP UP TO DO LIST—EVERY 15 MINUTES
   HISTORY OF TO DO LIST
   AUTO REMINDERS FOR BIRTHDATES
   MEDICAL REMINDERS—REFILL PILL BOX, REORDER MEDICINE
   CHARGE PHONE REMINDERS
   PRO VERSION: DIET TRACKING
   PRO VERSION: SUGAR LEVEL TRACKING AND HISTORY
   PRO VERSION: REMINDER TO DRINK WATER
   EXERCISE RECORD AND HISTORY
   FOR ASSISTED LIVING: INCORPORATED INTO APPLICATION ALONG WITH MENU OF HOME.
   AUTOMATICALLY BE SENT TO CALENDAR/APPOINTMENTS.
   MERGE OFFICE CALENDAR WITH PERSONAL CALENDAR
   SEAMLESSLY SYNC YOUR LISTS
   AMOUNT OF TIME CALCULATED BETWEEN APPOINTMENTS WITH AMOUNT OF TIME NEEDED FOR TRAVEL.
   SHOPPING LIST—STANDING DAILY/WEEKLY/MONTHLY
   MEDICINE LIST/HISTORY
   FLAG IMPORTANT TASKS WITH A FLAG OR TAG IT
   MOST IMPORTANT TASKS GO TO THE TOP OF THE LIST
UNIQUE FEATURES:
   SYNC WITH APPOINTMENTS AND GPS (HOW MUCH TIME NEEDED TO GET TO APPOINTMENT)
   WEATHER—APPROPRIATE CLOTHES SUGGESTION AND REMINDER
   REMINDER—YOUR FIRST APPOINTMENT WITH XYZ IS AT XYZ TIME YOU HAVE X HOURS/MINUTES BEFORE YOUR APPOINTMENT.
   ROLLING SYSTEM—INFORMATION IS GIVEN ON A TIMING SYSTEM—I.E. ORIENTATION OF DAY IS GIVEN BY PUSH NOTIFICATION, SHOWN FOR 2-3 MIN. THEN SUMMARY OF TODAY'S APPOINTMENTS IS GIVEN FOR 1-2 MINUTES, THEN WINDOW CLOSES AND NEW WINDOW AUTOMATICALLY OPENS FOR TODAY'S TO DO LIST.
   TO DO LIST—DONE AND NOT DONE REMINDERS, REMIND ME LATER OPTION
   APPOINTMENTS AND DAILY CALENDAR GOES TO NEXT DAYS TO DO LIST IF NOT DONE.
   PAID BILL HISTORY, MEDICAL HISTORY, SHOPPING LIST HISTORY
   APPROPRIATE AUTOMATIC PRE AND POST REMINDERS SYNCED WITH CONTACT—I.E. AT DOCTOR'S OFFICE REMIND DOCTOR TO REVIEW
   MEDICATION LIST
   FOLLOW-UP REMINDERS
   SECURED PAGE FOR INSURANCE INFORMATION AND EMERGENCY INFORMATION, MEDICAL INFORMATION
   COLOR CODED FOR EASY ASSOCIATION
   EMERGENCY CONTACTS
GPS—NAVIGATION FOR LOST PHONE
TECHNICAL ASSISTANCE—AUTO DIAL FOR TECHNICAL SUPPORT 24/7 U.S. BASED CUSTOMER SERVICE—HELP WITH SETUP, QUESTIONS AND GUIDANCE. NOTE: MINUTES ARE USED FOR SERVICE WHILE SPEAKING WITH OPERATOR AND FOR THE LENGTH OF ANY CALL THEY CONNECT FOR YOU.
FOLLOW—UP LIST
ENTRIES INTO CALENDAR CAN BE ENTERED BY VOICE/TEXT OR WEB ADMINISTRATOR OR ON THE GO FROM CAREGIVER TO USER.
WORKING ON A PHONE CASE WITH A HOOP FOR SOFT LANYARD TO BE ABLE TO WEAR AROUND NECK.

### Example of Calendar

CALENDAR—WEEK AT A GLANCE
TUES. JAN. 10 WED. JAN. 2 THURS. JAN. 3 FRI. JAN. 4 ETC.
12 AM
:15
:30
:45
1 AM
:15
GIVE CURRENT LOCATION I.E. HOME TO LOCATION OF APPOINTMENT. SAME FOR NEXT APPOINTMENT CURRENT TO NEXT LOCATION TO DETERMINE TIME OF TRAVEL.
SHOPPING LIST—Buy, Purchase, Return
Would you like to set/change the day of a Reminder to place an order? Yes/no. If yes, What day of the week? Every week, Every other week? Done/Not Done/save
See Active Shopping List Add/Delete?
View past purchases on Shopping List
Post-reminder questions: Is there anything else you need to buy? Add it to your Active Shopping List.
View my past purchases.
List for week ______
Enter category type/say first letter bring up list of items i.e.

| Category | Item | Amount | Special instructions |
|---|---|---|---|
| Oil | Olive Oil | 1 Large | cold pressed |

Add/Delete/Done/Not Done/save order on Shopping List if done, Are you ready to place your order? Call ______ grocery store i.e. Shoprite or go to Shoprite website—touch website, Touch Shopping List to view. Have your email address and password ready. Send List? Grocery Store (show address, phone #, email address—without exiting shopping list) Send copy of list to email address. (auto copy and send). Have your Credit card ready to pay.
Basic List: Touch and press Add to Shopping List
Milk—whole, 1%, 2%, skim, Skinny, skim milk plus
Juice—grape, grapefruit, orange juice, pulp, no pulp, some pulp
Eggs—Organic, Large, extra large
   Shopping List continued:
Vegetables—carrots, shredded carrots, coin carrots, snap peas, snow peas, peas, romaine lettuce, iceberg, mixed leaf, cucumber, tomato—cherry, grape tomato, vine tomato
Fruit—apples, bananas, pears, tangerine, clementine, pineapple, grapes, strawberries, blueberries, grapefruit, oranges, lemons, lime, raspberry etc.
   Paper goods:
Toilet paper 6,12,24
   Shopping List: Touch and press Add to Shopping list
   Paper Goods continued:
Paper towel 1,12,15
Tissues—large, small
Napkins—Dinner, Lunch
Paper plates—plastic, paper
Cups—styrofoam, paper, plastic—8 oz., 9 oz.
Garbage bags—Kitchen, Jumbo other
Aluminum paper—Heavy duty, regular
Foil pans—Large (roasting) medium, small (loaf pan)
Saran Wrap
Wax paper
Parchment paper
Paper lunch bags
Zip lock bags—freezer, storage, sandwich, snack
Category—Vegetable
Parsley—Italian, curly
   Shopping List continued:
Dill
Cilantro
Scallions
Chives
Broccoli Rabe
Broccoli—whole or head
Cucumber
Carrots, in bag, with stem
Green pepper, red pepper, orange/yellow, assorted
Squash—acorn, butternut, package in cubes
Mushrooms—cremini, caps, whole, other
Cauliflower
Corn on Cob—white, yellow
Eggplant
Brussel sprouts—bag, frozen
Parsnips
Turnips
Cabbage—green, purple
Potatoes—baked, Yukon, russet, red, white, sweet potatoes, yam
Onions—Yellow, Spanish, Vidalia, bag of yellow, red
Garlic
Shallots
Tomatoes—cherry, large, grape
Avocado
Other

### Dairy

Yogurt
Cheese
Cream cheese
   Shopping List continued:
Sour scream
Cottage cheese
Farmer cheese
Butter
Margarine
Other
Frozen
Vegetables
Ice cream
Potatoes
Waffles
Pancakes
Pizza

### Frozen

Meat
Fish

### Dry Goods

Coffee—ground, instant
Flour
Sugar—truvia, sweet and low, brown, raw, confectioners, granulated
Cookies
Crackers
Cereal

| Cleaning Items; | Laundry |
|---|---|
| Sos, Brillo | Detergent |
| Ajax | Bleach |
| Comet | Fabric Softener |
| Mr. Clean | Dryer sheets |
| | Febreeze |

Shopping List continued:
Shout
Roto Rooter
Pledge
Air freshener
Softscrub
Easy off
Ammonia
Silver polish
Sponge.
Rubber gloves
Mop
Matches

### Personal Items:

Soap—liquid, bar
   Shopping List continued:
Aspirin
Shampoo/conditioner
Diapers
Lotion
Deodorant

### Women's Needs

Sanitary Napkins
Tampons
Diapers
Pads

The present invention may be described herein in terms of functional block components, code listings, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices.

Similarly, the software elements of the present invention may be implemented with any programming or scripting language such as C, C++, C#, Java, COBOL, assembler, PERL, or the like, with the various algorithms being implemented with any combination of data structures, objects, processes, routines or other programming elements.

Further, it should be noted that the present invention may employ any number of conventional techniques for data transmission, signaling, data processing, network control, and the like.

It should be appreciated that the particular implementations shown and described herein are illustrative of the invention and its best mode and are not intended to otherwise limit the scope of the present invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical or virtual couplings between the various elements. It should be noted that many alternative or additional functional relationships or physical or virtual connections may be present in a practical electronic data communications system.

As will be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The present invention is described below with reference to block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems that perform the specified functions or steps, or suitable combinations of special purpose hardware and computer instructions.

One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

The scope of the invention should be determined by the appended claims and their legal equivalents, rather than by the examples given herein. For example, the steps recited in any method claims may be executed in any order and are not limited to the order presented in the claims. Moreover, no element is essential to the practice of the invention unless specifically described herein as “critical” or “essential.”

In the specification, the term “media” means any medium that can record data therein. The term “media” includes, for instance, a disk shaped media for such as CD-ROM (compact disc-read only memory), magneto optical disc or MO, digital video disc-read only memory or DVD-ROM, digital video disc-random access memory or DVD-RAM, a floppy disc, a memory chip such as random access memory or RAM, read only memory or ROM, erasable programmable read only memory or E-PROM, electrical erasable programmable read only memory or EE-PROM, a rewriteable card-type read only memory such as a smart card, a magnetic tape, a hard disc, and any other suitable means for storing a program therein.

A recording media storing a program for accomplishing the above mentioned apparatus maybe accomplished by programming functions of the above mentioned apparatuses with a programming language readable by a computer or processor, and recording the program on a media such as mentioned above.

A server equipped with a hard disk drive may be employed as a recording media. It is also possible to accomplish the present invention by storing the above mentioned computer program on such a hard disk in a server and reading the computer program by other computers through a network.

As a computer processing device, any suitable device for performing computations in accordance with a computer program may be used. Examples of such devices include a personal computer, a laptop computer, a microprocessor, a programmable logic device, or an application specific integrated circuit.

While this invention has been described by reference to a preferred embodiment, it should be understood that numerous changes could be made within the spirit and scope of the inventive concepts described. Accordingly, it is intended that the invention not be limited to the disclosed embodiment, but that it have the full scope permitted by the language of the following claims.

I claim:

1. A multipurpose device configured to run an application comprising
receiving an input to compile a schedule;
providing a user with discreet reminders to maintain the schedule.

2. The multipurpose device configured to run an application according to claim 1, wherein the input is provided by one of the user, a caregiver, and a doctor.

3. The multipurpose device configured to run an application according to claim 2, wherein the user is a patient.

4. The multipurpose device configured to run an application according to claim 3, wherein the patient is an Alzheimer patients.

5. The multipurpose device configured to run an application according to claim 4, wherein the application adapts as the user condition declines.

6. The multipurpose device configured to run an application according to claim 5, wherein the schedule comprises a daily schedule including one or more of shopping, doctor appointments, gym visits, hair salons, and entertainment.

7. The multipurpose device configured to run an application according to claim 6, wherein the scheduled activity further comprises a walk-through that prompts the user to at least one of perform activities and ask specific questions.

8. The multipurpose device configured to run an application according to claim 7, wherein the questions are adaptive.

9. The multipurpose device configured to run an application according to claim 2, wherein the schedule comprises administering a medication and the application prompts at least one of the user and the caregiver to submit evidence that the medication was administered.

10. The multipurpose device configured to run an application according to claim 9, wherein the evidence is one or more of a picture or a video of the medication being administered.

11. The multipurpose device configured to run an application according to claim 1, wherein the application or device is configured to communicate with one of a doctor application and a hospital application.

12. The multipurpose device configured to run an application according to claim 11, wherein the application is configured to provide selected patient data at least one of when queried and automatically.

13. The multipurpose device configured to run an application according to claim 12, wherein the patient data comprises at least one of patient name, age, date of birth, insurance information, current prescriptions, current diagnoses, and prior diagnoses, and the like.

14. The multipurpose device configured to run an application according to claim 7, wherein confirmation that the user complies with the schedule is sent to a third party.

15. The multipurpose device configured to run an application according to claim 14, wherein the confirmation is sent via a secure channel.

16. The multipurpose device configured to run an application according to claim 7, wherein the prompts are audio prompts.

17. The multipurpose device configured to run an application according to claim 16, wherein audio prompt is a voice known to the user.

18. The multipurpose device configured to run an application according to claim 1, further configured to:
monitor a location via GPS;
compare the location to an allowed user mobility range; and
issue an alarm if the user exceeds the allowed mobility range.

19. The multipurpose device configured to run an application according to claim 18, wherein the alarm comprises one or more of alerting a third party and providing an audio prompt to guide the user to a known location.
